(19) United States
(12) Patent Application Publication
(10) Pub. No.: US 2019/0034126 A1
(43) Pub. Date: Jan. 31, 2019

(54) CONTROL APPARATUS, INFORMATION PROCESSING CONTROL SYSTEM, AND METHOD OF CONTROLLING DATA TRANSMISSION

(71) Applicant: Shinya IWASHITA, Kanagawa (JP)

(72) Inventor: Shinya IWASHITA, Kanagawa (JP)

(21) Appl. No.: 16/047,231

(22) Filed: Jul. 27, 2018

(30) Foreign Application Priority Data
Jul. 31, 2017 (JP) 2017-148068

(51) Int. Cl. G06F 3/12; H04N 1/00

(52) U.S. Cl. CPC G06F 3/122; G06F 3/1204; G06F 3/1254; G06F 3/1231; G06F 3/1239; G06F 3/1292; H04N 1/00408

(57) ABSTRACT

A control apparatus, connectable with an external terminal and an information processing apparatus, includes circuitry configured to identify the information processing apparatus to receive target data, output from the external terminal, based on a condition uniquely set for the information processing apparatus, receive the target data output from the external terminal, and transmit the target data, received from the external terminal, to the identified information processing apparatus being a data transmission destination.

### CROSS-REFERENCE TO RELATED APPLICATION

This application claims priority pursuant to 35 U.S.C. § 119(a) to Japanese Patent Application No. 2017-148068, filed on Jul. 31, 2017, in the Japan Patent Office, the disclosure of which is incorporated by reference herein in its entirety.

### BACKGROUND

### Technical Field

The disclosure relates to a control apparatus, an information processing control system, and a method of controlling data transmission.

### Background Art

As more and more users use portable communication terminals such as notebook personal computers (PCs) and tablet terminals, the users carrying the portable communication terminals want to use printers and other devices through a network at various locations. For example, if a person visiting a company can use office apparatuses in the company, such as printers connected to a corporate network, from a portable communication terminal carried by the person, the person can use the office apparatuses effectively, with which productivity can be improved.

However, when a user carrying a communication terminal is to use apparatuses connected to a network, the communication terminal needs to install a dedicated software or application. For example, if the communication terminal is to transmit data to a printer after establishing communication with the printer, the communication terminal cannot perform printing unless a printer driver is installed in the communication terminal.

### SUMMARY

In one aspect of the present invention, a control apparatus connectable with an external terminal and an information processing apparatus is devised. The control apparatus includes circuitry configured to identify the information processing apparatus to receive target data, output from the external terminal, based on a condition uniquely set for the information processing apparatus, receive the target data output from the external terminal, and transmit the target data, received from the external terminal, to the identified information processing apparatus being a data transmission destination.

In another aspect of the present invention, an information processing control system is devised. The information processing control system includes an information processing apparatus configured to process target data received from an external terminal, and a control apparatus, controlling transmission of the target data from the external terminal to the information processing apparatus. The control apparatus includes circuitry configured to identify the information processing apparatus to be used as a data transmission destination of the target data, output from the external terminal, based on a condition uniquely set for the information processing apparatus, receive the target data output from the external terminal, and transmit the target data, received from the external terminal, to the identified information processing apparatus.

In another aspect of the present invention, a method of controlling data transmission from an external terminal to an information processing apparatus is devised. The method includes identifying the information processing apparatus as a data transmission destination of target data, output from the external terminal, based on a condition uniquely set for the information processing apparatus, receiving the target data output from the external terminal, and transmitting the target data, received from the external terminal, to the identified information processing apparatus.

### BRIEF DESCRIPTION OF THE DRAWINGS

A more complete appreciation of the description and many of the attendant advantages and features thereof can be readily obtained and understood from the following detailed description with reference to the accompanying drawings, wherein:

FIG. 1 illustrates an example of a schematic configuration of an information processing control system of a first embodiment;

FIG. 2 illustrates an example of a configuration of the information processing control system of the first embodiment;

FIG. 3 illustrates an example of a configuration of the information processing control system of the first embodiment when generating connection information;

FIG. 4 illustrates an example of a hardware block diagram of a control apparatus of the first embodiment;

FIG. 5 illustrates an example of hardware block diagram of an information processing apparatus of the first embodiment;

FIG. 6 illustrates an example of hardware block diagram of an administrator terminal of the first embodiment;

FIG. 7 illustrates an example of functional block diagram of the information processing control system of the first embodiment;

FIG. 8 illustrates an example of an apparatus list of the first embodiment;

FIG. 9 illustrates an example of a sequence diagram of processing for acquiring apparatus information in the information processing control system of the first embodiment;

FIGS. 10A and 10B illustrate an example of a sequence diagram of generating connection information in the information processing control system of the first embodiment;

FIG. 11 illustrates an example of a flowchart illustrating the steps of processing of a generation unit of the first embodiment;

FIG. 12 illustrates an example of a display image displayed on the administrator terminal of the first embodiment;

FIG. 13 illustrates an example of connection information printed by the information processing apparatus of the first embodiment;

FIGS. 14A and 14B illustrate an example of a sequence diagram of printing process in the information processing control system of the first embodiment;

FIG. 15 illustrates an example of an upload-use page of the first embodiment;

FIG. 16 illustrates an example of a flowchart illustrating the steps of processing of an identification unit of the first embodiment;

FIG. 17 illustrates an example of an apparatus list of a variant example 1 of the first embodiment;

FIG. 18 illustrates an example of an apparatus list of a variant example 2 of the first embodiment;

FIG. 19 is an example of a mail transmission screen of the variant example 2 of the first embodiment;

FIG. 20 illustrates an example of an information processing control system of a variant example 3 of the first embodiment;

FIG. 21 illustrates an example of functional block diagram of an information processing control system of a second embodiment;

FIG. 22 illustrates an example of an apparatus list of the second embodiment;

FIG. 23 illustrates an example of management information of the second embodiment;

FIG. 24 illustrates an example of a flowchart illustrating the steps of processing a control apparatus of the second embodiment;

FIG. 25 illustrates an example of management information of a variant example of the second embodiment;

FIG. 26 illustrates an example of a flowchart illustrating the steps of processing a control apparatus of a variant example of the second embodiment;

FIG. 27 illustrates an example of functional block diagram of an information processing control system of a third embodiment;

FIG. 28 illustrates an example of print setting information of the third embodiment;

FIG. 29 illustrates a scheme of processing of a data processing unit of a control apparatus of the third embodiment;

FIG. 30 illustrates an example of a sequence diagram of printing process in the information processing control system of the third embodiment;

FIG. 31 illustrates an example of a flowchart illustrating the steps of processing in a data processing unit of the control apparatus of the third embodiment;

FIG. 32 illustrates an example of functional block diagram of an information processing control system of a fourth embodiment;

FIG. 33 illustrates an example of an apparatus list of the fourth embodiment;

FIG. 34 illustrates an example of a display image displayed using an operation unit of the fourth embodiment;

FIGS. 35A and 35B illustrate an example of a sequence diagram of display processing of connection information in the information processing control system of the fourth embodiment;

FIG. 36 illustrates an example of a sequence diagram of generating connection information in an information processing control system of a variant example of the fourth embodiment;

FIG. 37 illustrates an example of a system configuration of an information processing control system of a fifth embodiment; and

FIG. 38 illustrates an example of display setting information of the fifth embodiment.

The accompanying drawings are intended to depict embodiments of the present invention and should not be interpreted to limit the scope thereof. The accompanying drawings are not to be considered as drawn to scale unless explicitly noted.

### DETAILED DESCRIPTION

A description is now given of exemplary embodiments of the present invention. It should be noted that although such terms as first, second, etc. may be used herein to describe various elements, components, regions, layers and/or units, it should be understood that such elements, components, regions, layers and/or units are not limited thereby because such terms are relative, that is, used only to distinguish one element, component, region, layer or unit from another region, layer or unit. Thus, for example, a first element, component, region, layer or unit discussed below could be termed a second element, component, region, layer or unit without departing from the teachings of the present invention.

In addition, it should be noted that the terminology used herein is for the purpose of describing particular embodiments only and is not intended to be limiting of the present invention. Thus, for example, as used herein, the singular forms “a”, “an” and “the” are intended to include the plural forms as well, unless the context clearly indicates otherwise. Moreover, the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Hereinafter, a description is given of one or more embodiments of the present invention with reference to the drawings. Note that the same reference numerals are assigned to the same elements in the description of the drawings, and the overlapping descriptions are omitted.

### First Embodiment

### System Configuration:

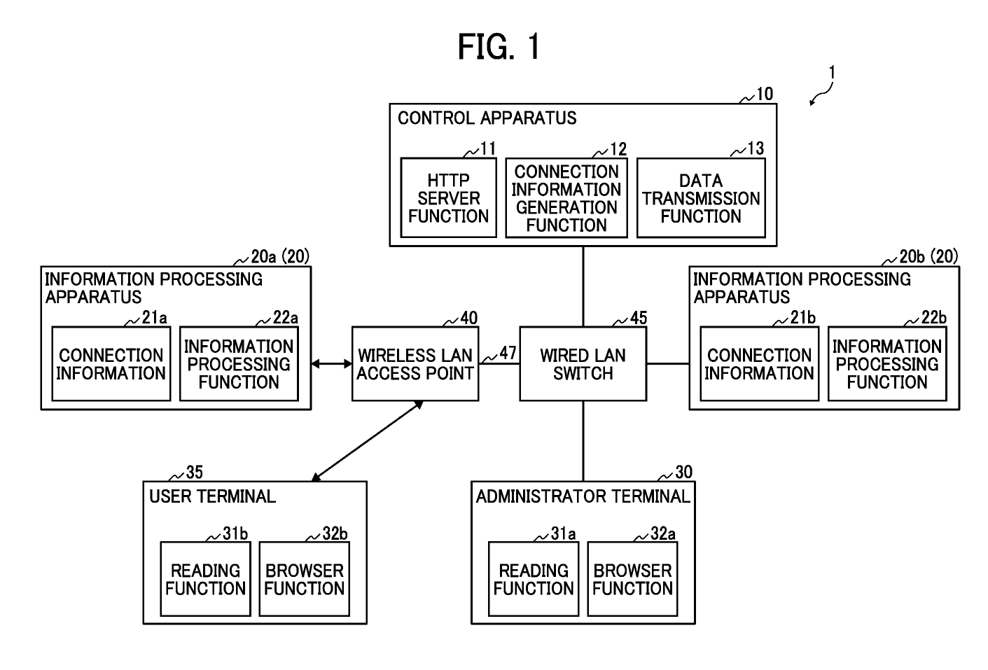

FIG. 1 illustrates an example of a schematic configuration of an information processing control system 1 of a first embodiment. As illustrated in FIG. 1, the information processing control system 1 includes, for example, a control apparatus 10, an information processing apparatus 20 (20a, 20b), an administrator terminal 30, a user terminal 35, a wireless local area network (LAN) access point 40, and a wired local area network (LAN) switch 45. The information processing control system 1 is a system capable of transmitting data, output from the user terminal 35, to a specific information processing apparatus such as the information processing apparatus 20 to be used by a user carrying the user terminal 35 without installing a dedicated software or application for utilizing the specific information processing apparatus 20 in the user terminal 35.

The information processing control system 1 is the system that communicates data between apparatuses or devices connected to a network, such as a local area network (LAN), constructed in an organization or entity, such as a company. In the information processing control system 1, when a user is to transmit to-be-processed data (i.e., target data) from the user terminal 35 (or the administrator terminal 30) to a specific information processing apparatus selected from information processing apparatuses 20a and 20b, the user terminal 35 or the administrator terminal 30 can transmit the target data to the selected specific information processing apparatus 20 via the control apparatus 10.

As illustrated in FIG. 1, the information processing control system 1 includes, for example, the control apparatus 10, the information processing apparatus 20 (20a, 20b), the administrator terminal 30, the user terminal 35, the wireless LAN access point 40, and the wired LAN switch 45. The control apparatus 10 is connected to a communication line 47 via the wired LAN switch 45. The control apparatus 10 can communicate with the information processing apparatus 20b, the administrator terminal 30, and the wireless LAN access point 40 via the wired LAN switch 45 and the communication line 47. The communication line 47 is a wired communication line configured with the wired LAN switch 45.

The information processing apparatus 20a and the user terminal 35 are connected to the wireless LAN access point 40 using the wireless communication. The information processing apparatus 20a and the user terminal 35 can communicate with devices connected to the communication line 47 via the wireless LAN access point 40 connected to the wired LAN switch 45.

The control apparatus 10 controls transmission of data, output from an external terminal such as the user terminal 35 or the administrator terminal 30, to the information processing apparatus 20. As illustrated in FIG. 1, the control apparatus 10 includes, for example, a hypertext transfer protocol (HTTP) server function 11, a connection information generation function 12, and a data transmission function 13.

The connection information generation function 12 generates connection information 21 based on a request from the administrator terminal 30. The connection information 21 is, for example, a two-dimensional code such as a QR code (registered trademark), but not limited thereto. The connection information 21 includes, for example, information of destination of outputting data (hereinafter, output destination information or first destination information), such as information of upload-use page for uploading data (i.e., target data) to be processed by the information processing apparatus 20. The first destination information corresponds to a data transfer destination where the target data is output from the external terminal, such as the user terminal 35, before the target data is transmitted to the information processing apparatus 20 used as a destination of transmitting data. The output destination information indicates a destination of the target data output from an external terminal such as the user terminal 35. The output destination information is, for example, a uniform resource locator (URL) set for the upload-use page. Further, the upload-use page is an area for outputting the target data from the external terminal such as the user terminal 35. The upload-use page is, for example, a web page assigned for each information processing apparatus 20. The control apparatus 10 transmits the generated connection information 21 to the information processing apparatus 20 identified by the connection information 21.

The HTTP server function 11 includes, for example, a function of receiving a request from the external terminal such as the user terminal 35 using a web browser. The HTTP server function 11 activates an HTTP server, and acquires the target data uploaded on the upload-use page from the user terminal 35 using the web browser.

The data transmission function 13 transmits the acquired target data to a specific information processing apparatus 20, selected from the information processing apparatus 20a and the information processing apparatus 20b, to be used by a user carrying the user terminal 35a. Since the upload-use page is a page assigned for or associated with each of the information processing apparatuses 20, the control apparatus 10 can transmit the target data to the specific information processing apparatus 20 uniquely corresponded to the area (i.e., upload-use page) where the target data is uploaded from the user terminal 35a.

The information processing apparatus 20 is, for example, an image forming apparatus having a printing function such as a multifunction apparatus, a printer and the like, but not limited thereto. As illustrated in FIG. 1, the information processing control system 1 includes, for example, two or more information processing apparatuses 20, such as the information processing apparatuses 20a and 20b, in a network system constructed in an entity, such as a company. The information processing apparatus 20 is set with the connection information 21. For example, the information processing apparatus 20 stores the connection information 21 generated by the control apparatus 10. Further, the information processing apparatus 20 manages the connection information 21 uniquely corresponded to the information processing apparatus 20. Specifically, the information processing apparatus 20a manages the connection information 21a set for the information processing apparatus 20a, and the information processing apparatus 20b manages the connection information 21b set for the information processing apparatus 20b.

The information processing apparatus 20 further includes an information processing function 22. The information processing function 22 performs image processing on a job request (e.g., printing, scanning) transmitted from the user terminal 35 (e.g., tablet terminal). FIG. 1 describes an example case that the information processing control system 1 includes two information processing apparatuses 20, but the number of the information processing apparatuses 20 can be any numbers, such as one, two, three or more.

The administrator terminal 30 is a terminal device or apparatus used by an administrator of the information processing control system 1. The administrator terminal 30 can be a personal computer having a general configuration, such as a notebook personal computer (PC), but not limited thereto. As illustrated in FIG. 1, the administrator terminal 30 includes, for example, a reading function 31a, and a browser function 32a. The reading function 31a reads or captures the connection information 21 using an image capturing mechanism such as a camera. The browser function 32a functions as a general web browser that serves as a hypertext transfer protocol (HTTP) client to describe data in a language, such as hypertext markup language (HTML).

The user terminal 35 is an example of the external terminal used by an external user of the information processing control system 1, such as a user not having authentication information for logging in the information processing control system 1. The user terminal 35 is, for example, a mobile terminal device, such as a tablet terminal, operable by the user.

As illustrated in FIG. 1, the user terminal 35 includes, for example, a reading function 31b, and a browser function 32b. The reading function 31b and the browser function 32b are functions similar to the reading function 31a and the browser function 32a of the administrator terminal 30. The user terminal 35 can be, for example, a mobile phone terminal, a smart phone, a game machine, a personal digital assistant (PDA), a digital camera, a wearable PC, a notebook PC, or the like.

The wireless LAN access point 40 communicates with the information processing apparatus 20a and the user terminal 35 in accordance with the standard of a wireless LAN such as Institute of Electrical and Electronic Engineers (IEEE) 802.11. The wired LAN switch 45 is a switch capable of switching between devices connected to a wired LAN such as Ethernet (registered trademark).

Further, the wireless LAN access point 40 is connected to the wired LAN switch 45 via a wired LAN, with which the information processing apparatus 20a, the user terminal 35, the control apparatus 10, the information processing apparatus 20b, and the administrator terminal 30 can communicate with each other. The connection relationship between the devices is not limited thereto. For example, the information processing control system 1 can omit the wired LAN switch 45, in which all apparatuses or devices communicate with each other via the wireless LAN access point 40.

### Information Processing Control System:

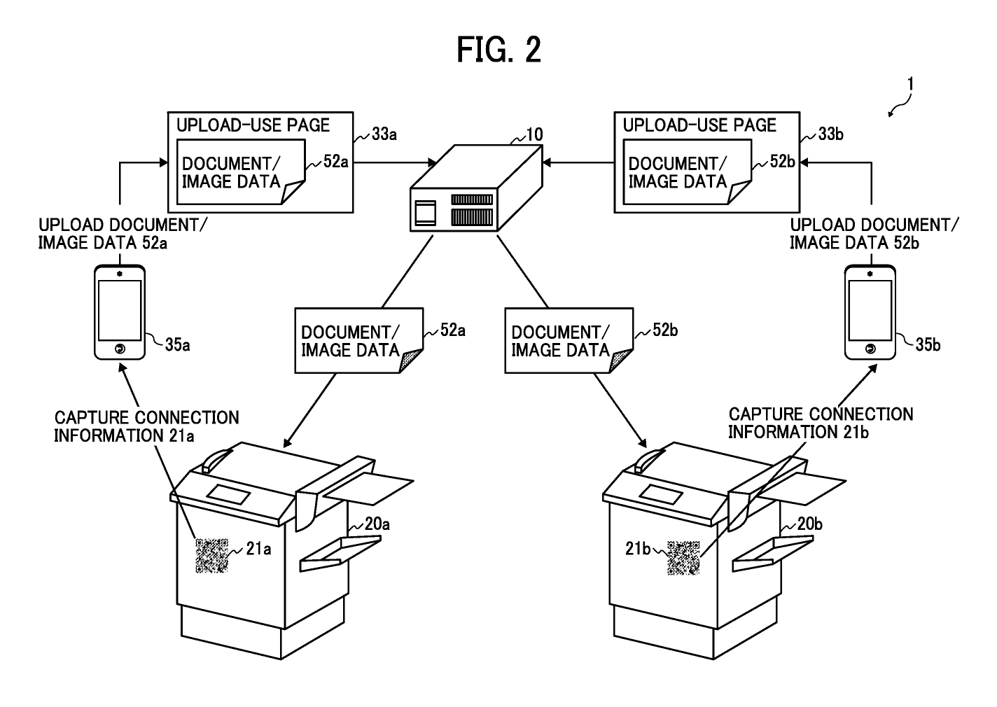

FIG. 2 illustrates an example of a configuration of the information processing control system 1 of the first embodiment. In an example case of FIG. 2, the control apparatus 10 controls transmission of the target data from the user terminal 35 to the information processing apparatus 20. In the first embodiment, the information processing apparatus 20 is described as an image processing apparatus such as a printer having a printing function, but not limited thereto.

In the example case of FIG. 2, a user (e.g., first user) using the user terminal 35a wants to print document/image data 52a stored in the user terminal 35a using the information processing apparatus 20a located near the user (first user). On the other hand, another user (e.g., second user) using the user terminal 35b wants to print document/image data 52b stored in the user terminal 35b using the information processing apparatus 20b located near another user (second user).

The user terminal 35a reads the connection information 21a associated with the information processing apparatus 20a using the reading function 31b. The connection information 21a is a two-dimensional code such as a QR code (registered trademark). The connection information 21a is, for example, printed on a sheet (e.g. paper) using the information processing apparatus 20a. The sheet printed with the connection information 21a is attached to, for example, a housing of the information processing apparatus 20a. The sheet printed with the connection information 21a can be placed on or near the information processing apparatus 20a so that the user can recognize that the connection information 21a uniquely corresponds to the information processing apparatus 20a. For example, the sheet printed with the connection information 21a can be placed on a face of the information processing apparatus 20a (e.g. top face) or beside the information processing apparatus 20a. With this configuration, the connection information 21a is uniquely associated with the information processing apparatus 20a.

The user terminal 35a captures and reads information included in the connection information 21a by capturing the connection information 21a associated with the information processing apparatus 20a. The connection information 21a includes, for example, the output destination information indicating an output destination of the document/image data 52a (i.e., target data) to be printed by the information processing apparatus 20a. The output destination information is, for example, a URL of an upload-use page 33a used for uploading the document/image data 52a. Then, the user terminal 35a accesses the upload-use page 33a corresponding to the read connection information 21a, and uploads the document/image data 52a (i.e., target data) to the upload-use page 33a.

The control apparatus 10 accesses the upload-use page 33a to acquire the document/image data 52a uploaded from the user terminal 35a. The control apparatus 10 identifies the information processing apparatus 20, which is a to-be-destination of the acquired document/image data 52a based on a pre-set condition uniquely set for each of the information processing apparatuses 20, which means the pre-set conditions set for the information processing apparatuses 20 are different among the information processing apparatuses 20. Specifically, since the upload-use page 33a is associated with the information processing apparatus 20a in an apparatus list 50, to be described later, the control apparatus 10 identifies the information processing apparatus 20a as a destination of transmitting the document/image data 52a. The information of the destination of transmitting the document/image data 52a is referred to as the transmission destination information or second destination information. The second destination information corresponds to a data transmission destination of the target data, such as the identified information processing apparatus 20 where the target data is processed (e.g., printing, displaying). The first destination information and the second destination information can be associated with each other.

The control apparatus 10 transmits the document/image data 52a to the identified information processing apparatus 20a. Then, the information processing apparatus 20a performs printing of the received document/image data 52a. Similarly, the control apparatus 10 can transmit the document/image data 52b uploaded to the upload-use page 33b from the user terminal 35b to the information processing apparatus 20b.

As above described, in the information processing control system 1, the document/image data 52 (i.e., target data) is transmitted to the control apparatus 10 from the user terminal 35 using the upload-use page 33 set for each information processing apparatus 20 and included in the connection information 21 uniquely associated with each information processing apparatus 20. Then, the control apparatus 10 transmits the received document/image data 52 to the information processing apparatus 20 associated with the upload-use page 33. Therefore, in the information processing control system 1, the document/image data 52 (i.e., target data) can be easily transmitted to the to-be-used information processing apparatus 20 from the user terminal 35 without installing a dedicated software or application program in the user terminal 35.

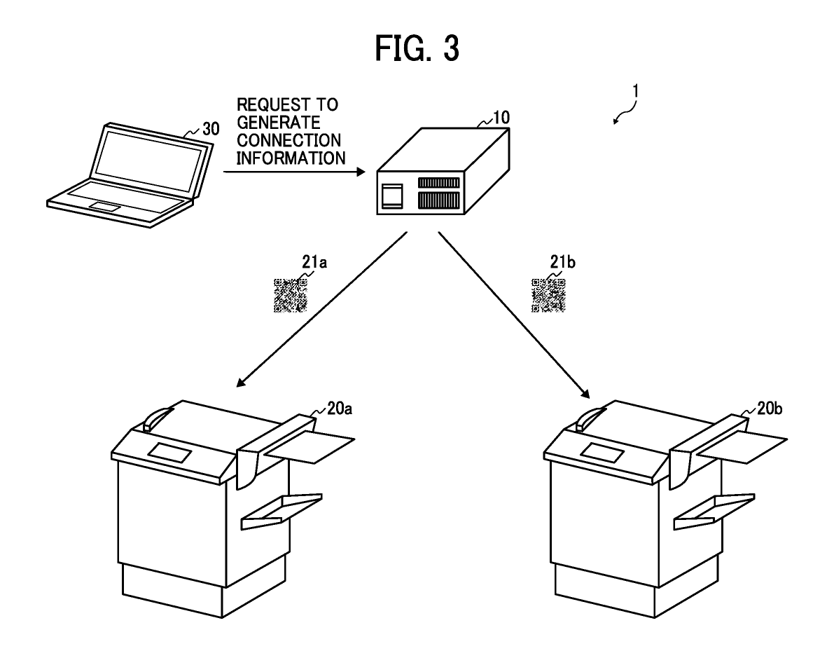

Hereinafter, a description is given of a process for generating the connection information 21 using the control apparatus 10 with reference to FIG. 3. FIG. 3 illustrates an example of a configuration of the information processing control system 1 of the first embodiment when generating the connection information 21. At first, the administrator terminal 30 transmits a request for generating the connection information 21 to the control apparatus 10. After receiving the request for generating the connection information 21, the control apparatus 10 generates the connection information 21 based on apparatus information 51 included in the apparatus list 50, to be described later. The control apparatus 10 generates the connection information 21 for each of the information processing apparatuses 20 connected to the network. Then, the control apparatus 10 respectively transmits the connection information 21a and the connection information 21b to the information processing apparatus 20a and the information processing apparatus 20b as the connection information 21 uniquely corresponded to each of the information processing apparatuses 20.

The information processing apparatus 20a performs printing of the received connection information 21a. As described above, the sheet printed with the connection information 21a can be attached to the information processing apparatus 20a such as the connection information 21a is put on a face of the information processing apparatus 20a (e.g. top face), with which a user can recognize that the connection information 21a uniquely corresponds to the information processing apparatus 20a that the user wants to use. With this configuration, the connection information 21a is uniquely associated with the information processing apparatus 20a.

Similarly, the information processing apparatus 20b performs printing of the received connection information 21b. As described above, the sheet printed with the connection information 21b can be attached to the information processing apparatus 20b such as the connection information 21b is put on a face of the information processing apparatus 20b (e.g. top face), with which a user can recognize that the connection information 21b uniquely corresponds to the information processing apparatus 20a that the user wants to use. Further, the information processing apparatus 20 can be configured not to perform printing of the received connection information 21. In this case, the information processing apparatus 20 and the connection information 21 are uniquely associated with any style so that a user can recognize that the connection information 21 is uniquely associated with the information processing apparatus 20.

As above described, the control apparatus 10 generates the connection information 21 including the output destination information indicating the output destination of data associated with each of the information processing apparatuses 20. Then, the control apparatus 10 transmits the generated connection information 21 to the information processing apparatus 20 uniquely corresponded to the connection information 21. Therefore, when the user terminal 35 reads the connection information 21 associated with the information processing apparatus 20, to be used by the user terminal 35, the user of the user terminal 35 can easily transmit the document/image data 52 (i.e., target data to be printed) to the information processing apparatus 20 to be used by the user terminal 35. Hardware Configuration:

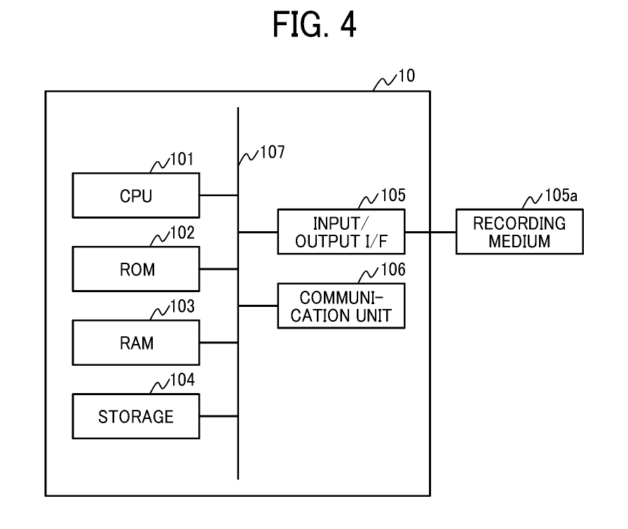

FIG. 4 illustrates an example of a hardware block diagram of the control apparatus 10 of the first embodiment. The hardware configuration illustrated in FIG. 4 may have a similar configuration in each of the following embodiments while some components may be added or deleted as needed. As illustrated in FIG. 4, the control apparatus 10 includes, for example, a central processing unit (CPU) 101, a read only memory (ROM) 102, a random access memory (RAM) 103, a storage 104, an input/output interface (I/F) 105, a communication unit 106, and a bus 107.

The CPU 101 is a computing device, such as circuitry, which implements functions of the control apparatus 10 by executing programs and data read from the ROM 102 or the storage 104 and loaded on the RAM 103. The control apparatus 10 performs an information processing control method of the embodiments by executing programs of the embodiments.

The ROM 102 is a nonvolatile memory capable of retaining programs and data even when a power supply is turned off. The ROM 102 is, for example, a flash ROM. The ROM 102 is installed with a software development kit (SDK) corresponding to a variety of applications. The ROM 102 can be used to implement various functions and network connections of the control apparatus 10 using the applications of the SDK. The RAM 103 is a volatile memory used as a work area of the CPU 101.

The storage 104 is a storage device, such as a hard disk drive (HDD), a solid state drive (SSD), or the like. The storage 104 stores an operating system (OS), application programs, and various data. The input/output I/F 105 is an interface for connecting an external device to the control apparatus 10. The external device includes, for example, a recording medium 105a, such as a universal serial bus (USB) memory, a memory card, an optical disk, or various electronic devices.

The communication unit 106 is an interface used for communicating with the information processing apparatus 20, the administrator terminal 30, and the user terminal 35 under the instruction of the CPU 101. The communication unit 106 may be connected to the network using the wired communication, and may be connected to the network using the wireless communication such as wireless LAN. Further, the communication unit 106 may also include a digital service unit (DSU) or a modem connected to a telephone network. Further, the communication unit 106 may also include a communication device connected to a mobile telephone network.

The bus 107 is connected to the above components, and is used to transmit address signals, data signals, and various control signals. The CPU 101, the ROM, the 102, the RAM 103, the storage 104, the input/output I/F 105, and the communication unit 106 are connected with each other via the bus 107.

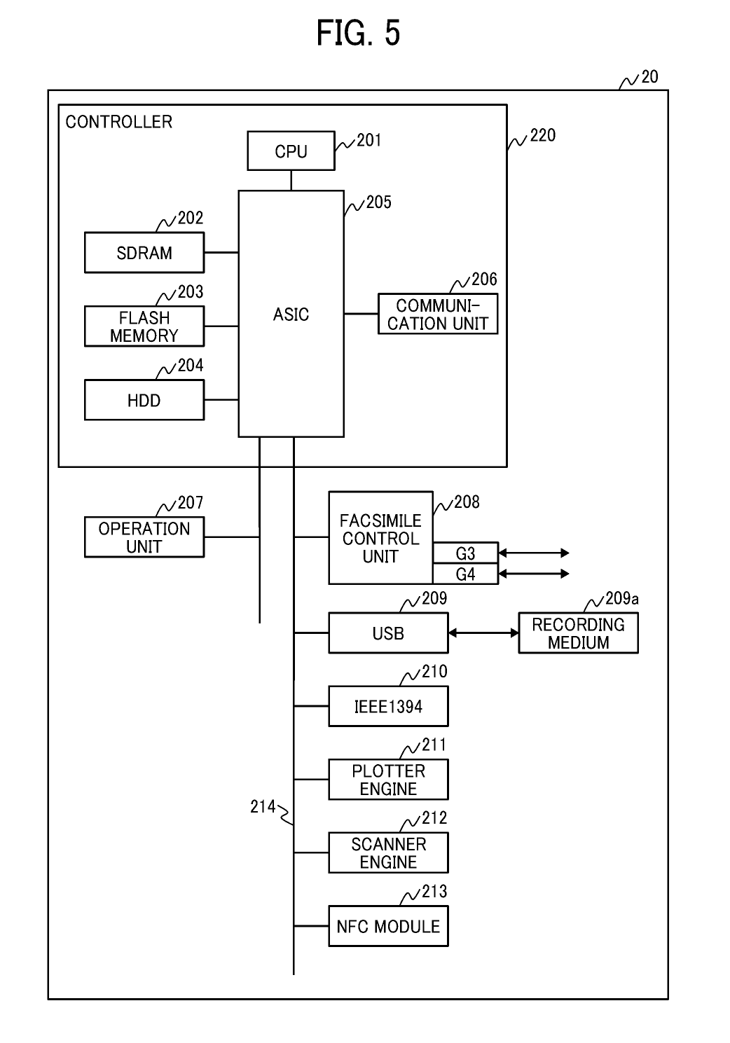

FIG. 5 illustrates an example of hardware block diagram of the information processing apparatus 20 of the first embodiment. The hardware configuration illustrated in FIG. 5 may have a similar configuration in each of the embodiments, and some components may be added or deleted as needed. As illustrated in FIG. 5, the information processing apparatus 20 includes, for example, a controller 220. The controller 220 includes, for example, a CPU 201, a synchronous dynamic random access memory (SDRAM) 202, a flash memory 203, an HDD 204, an application specific integrated circuit (ASIC) 205, and a communication unit 206.

The ASIC 205 is a multi-functional device board including a CPU interface, an SDRAM interface, a local bus interface, a peripheral component interconnect (PCI) bus interface, a media access controller (MAC), and an HDD interface.

The CPU 201 reads and executes various programs loaded from the HDD 204 via the ASIC 205. The SDRAM 202 functions as a program memory for storing various programs, and a work memory when the CPU 201 executes various programs. Instead of the SDRAM 202, a dynamic random access memory (DRAM) or a static random access memory (SRAM) may be used.

The flash memory 203 is a nonvolatile memory, and stores a boot loader (boot program) and an OS for activating the information processing apparatus 20. Further, the flash memory 203 functions as an application memory for storing each program. Further, the flash memory 203 functions as a service memory for storing software of each service (e.g., copy service, print service, facsimile service).

Further, the flash memory 203 functions as a firmware memory storing firmware, and a data memory storing a network address, a device number and the like. Instead of the flash memory 203, a non-volatile RAM, which integrates a backup circuit using a RAM and a battery, or other nonvolatile memory such as an electrically erasable programmable read-only memory (EEPROM) can be used.

The HDD 204 is a nonvolatile storage medium that stores data regardless of whether power of the multifunction peripheral is turned on or off. The HDD 204 stores programs and data other than programs and data stored in the flash memory 203. Further, the HDD 204 may be used as a firmware memory. The communication unit 206 is an interface for communicating with the control apparatus 10, the administrator terminal 30, and the user terminal 35 under the instruction of the CPU 201.

An operation unit 207 is connected to the controller 220 using a USB cable or the like. The operation unit 207 is an interface for a user who operates the information processing apparatus 20. The operation unit 207 includes, for example, various operation keys, a display such as a liquid crystal display (LCD), an image display such as a cathode ray tube (CRT), and a touch panel. By operating the operation unit 207 by the user, the information processing apparatus 20 can be used to input data, execute a job, and display data.

Further, the controller 220 is connected to a facsimile control unit 208, a USB 209 detachable of a recording medium 209a, a IEEE “1394” 210, a plotter engine 211, a scanner engine 212, a near field communication (NFC) module 213 via a PCI bus 214. With this configuration, the information processing apparatus 20 can provide various services such as copy service, print service, facsimile service, and the like. The plotter engine 211 may employ either the electrophotographic system or the inkjet system.

The configuration illustrated in FIG. 5 is just one example, and the hardware configuration of the information processing apparatus 20 is not limited to the configuration of FIG. 5. For example, the communication unit 206 may be connected to the PCI bus 214. Further, the communication unit 206 may be connected to a network by wire or wirelessly using a wireless LAN. Further, the communication unit 206 may also include a digital service unit (DSU) or a modem connected to a telephone network. Further, the communication unit 206 may also include a communication device connected to a mobile telephone network.

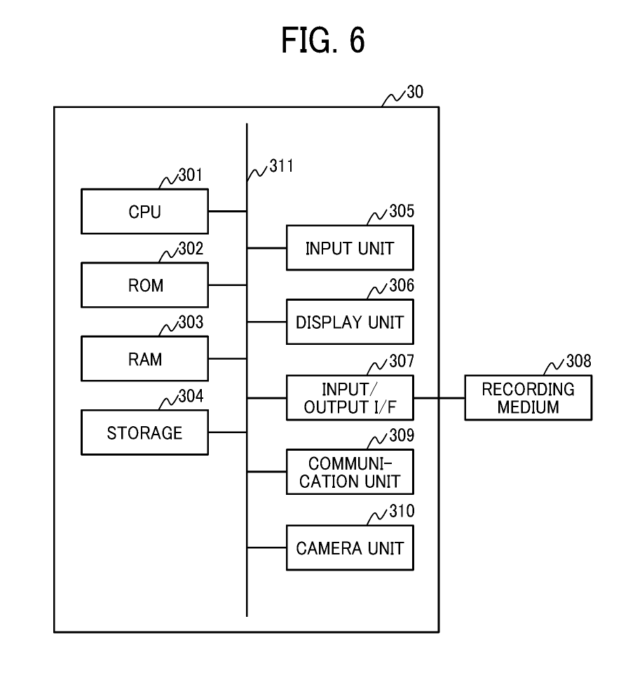

FIG. 6 illustrates an example of hardware block diagram of the administrator terminal 30 of the first embodiment. The hardware configuration illustrated in FIG. 6 may have a similar configuration in each of the embodiments, and some components may be added or deleted as needed. The user terminal 35 may have a hardware configuration similar to the hardware configuration illustrated in FIG. 6.

As illustrated in FIG. 6, the administrator terminal 30 includes, for example, a CPU 301, a ROM 302, a RAM 303, a storage 304, an input unit 305, a display unit 306, an input/output interface (I/F) 307, a communication unit 309, a camera unit 310, and a bus 311.

The CPU 301 controls the administrator terminal 30 entirely. The CPU 301 is a computing device, such as circuitry, which implements functions of the administrator terminal 30 by executing programs and data read from the ROM 302 or the storage 304 and loaded to the RAM 303.

The RAM 303 is a volatile memory used as a work area of the CPU 301. The ROM 302 is a nonvolatile memory capable of retaining programs and data even when a power supply is turned off. The storage 304 is, for example, a storage device such as an HDD, SSD, or flash ROM, and stores an OS, application programs, and various data.

The input unit 305 receives an input for performing an operation of the administrator terminal 30. The input unit 305 includes, for example, an input device, such as a keyboard, a mouse, a touch panel, and a voice input device. The display unit 306 displays a result of processing of the administrator terminal 30. The display unit 306 displays, for example, various types of information processed by the administrator terminal 30 on a display in the form of a cursor, a menu, a window, a character, or an image under a request from the CPU 301. The display unit 306 is, for example, a display such as a liquid crystal display (LCD).

The input unit 305 or the display unit 306 may be provided outside the administrator terminal 30. The input unit 305 and the display unit 306 may be, for example, an integrated display input unit such as a touch panel display.

The input/output I/F 307 is an interface for connecting an external device to the administrator terminal 30. The external apparatus includes, for example, a recording medium 308 such as a USB memory, a memory card, an optical disk, or various electronic devices.

The communication unit 309 is a communication interface that performs communication (connection) with the control apparatus 10 and the information processing apparatus 20 via the network. The communication unit 309 includes, for example, an antenna, a radio unit, a MAC unit, and the like. The camera unit 310 is an imaging apparatus for capturing an image within an imaging range.

The bus 311 is connected to the above components, and is used to transmit address signals, data signals, and various control signals. The CPU 301, the ROM 302, the RAM 303, the storage 304, the input unit 305, the display unit 306, the input/output I/F 307, the communication unit 309 and the camera unit 310 are connected with each other via the bus 311.

### Functional Configuration:

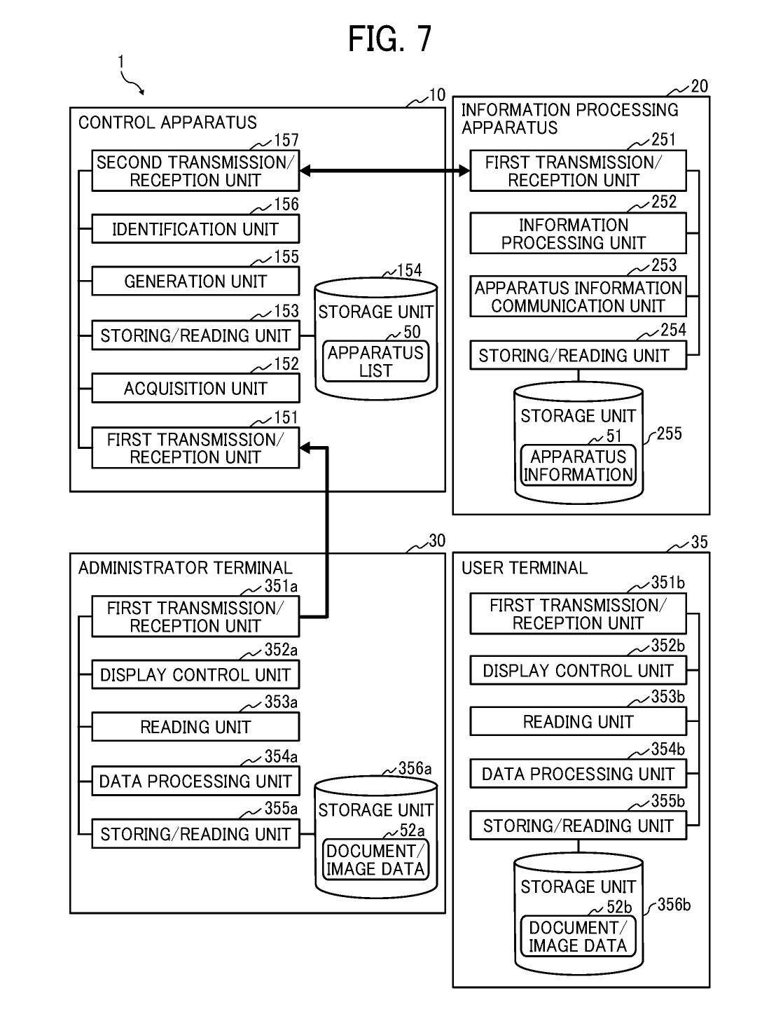

FIG. 7 illustrates an example of a functional block diagram of the information processing control system 1 of the first embodiment. As illustrated in FIG. 7, the functions implemented by the control apparatus 10 includes, for example, a first transmission/reception unit 151, an acquisition unit 152, a storing/reading unit 153, a storage unit 154, a generation unit 155, an identification unit 156, and a second transmission/reception unit 157.

The first transmission/reception unit 151 has a function of transmitting and receiving data between the administrator terminal 30 and the user terminal 35. The first transmission/reception unit 151 serves as the HTTP server function 11 for receiving a request from an external terminal, such as the user terminal 35, using a web browser. The first transmission/reception unit 151 receives the target data uploaded from the external terminal such as the administrator terminal 30 or the user terminal 35 on the upload-use page 33 corresponded to the output destination information included in the connection information 21. The first transmission/reception unit 151 is implemented by, for example, the communication unit 106 and executing programs using the CPU 101 of the control apparatus 10 illustrated in FIG. 4.

The acquisition unit 152 acquires the apparatus information 51 of the information processing apparatus 20. For example, the acquisition unit 152 transmits an information acquisition request to the information processing apparatus 20 connected to the control apparatus 10 via the network. Then, the acquisition unit 152 acquires the apparatus information 51 from the information processing apparatus 20 in response to the information acquisition request. The information acquisition request and the response to the information acquisition request is performed using any protocol, such as simple service discovery protocol (SSD), simple network management protocol (SNMP), and multicast domain name system (DNS).

Further, in another case, the acquisition unit 152 can be configured to acquire the apparatus information 51, input to the administrator terminal 30 used by the administrator of the information processing control system 1, by transmitting the apparatus information 51 from the administrator terminal 30 to the control apparatus 10. The acquisition unit 152 is implemented by, for example, executing programs using the CPU 101 of the control apparatus 10 illustrated in FIG. 4. The acquisition unit 152 is an example of the acquisition unit.

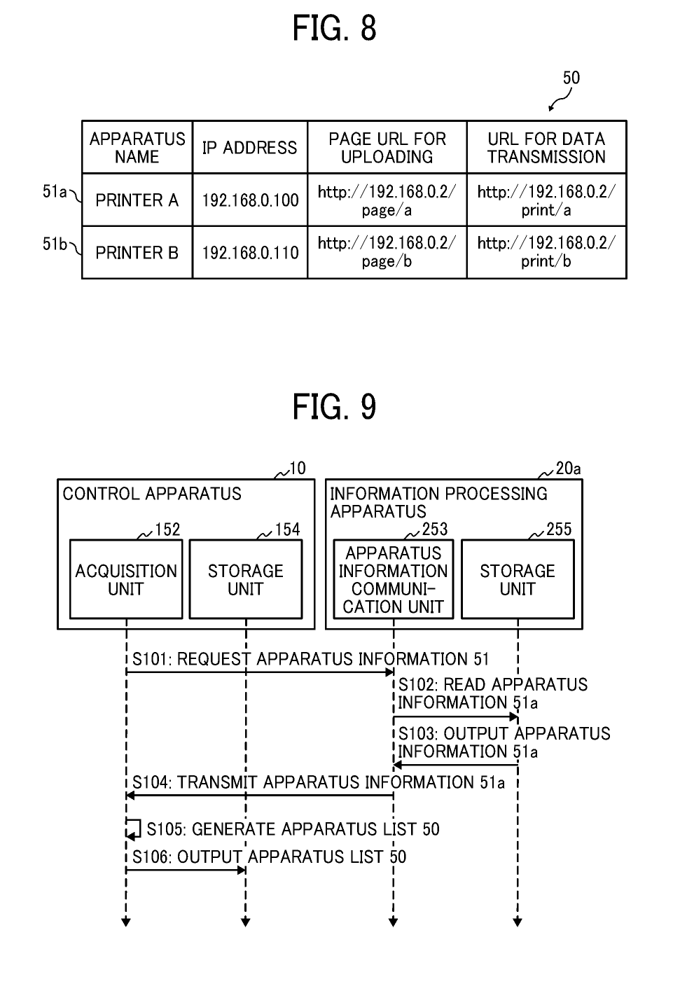

Hereinafter, a description is given of a detail of the apparatus information 51 acquired by the acquisition unit 152 with reference to FIG. 8. FIG. 8 illustrates an example of the apparatus list 50 of the first embodiment. The apparatus list 50 is a list of the apparatus information 51, set for each of the information processing apparatuses 20, which are acquired by the acquisition unit 152. The apparatus list 50 is stored in the storage unit 154. The apparatus information 51 includes items, such as an apparatus name, an internet protocol (IP) address, a page universal resource locator (URL) used for uploading (upload-use page URL), and a URL used for data transmission associated with each other.

The apparatus name is used as information identifying each of the information processing apparatuses 20, such as printer A or printer B. The apparatus name is arbitrarily set by the information processing apparatus 20 or the administrator terminal 30. Further, the apparatus name can be information that is easily understood by a user such as “printer of the first-floor lounge” or “printer of the third-floor conference room.” When the apparatus information 51 is assigned to each of the information processing apparatuses 20, the user terminal 35 that acquires the apparatus information 51 can uniquely identify the information processing apparatus 20, and further, by displaying the apparatus name on an operation screen of the user terminal 35 that acquires the apparatus information 51, the user or administrator can clearly confirm which apparatus is used by seeing the apparatus name.

The IP address is an address of the information processing apparatus 20. The IP address indicates a destination of the information processing apparatus 20 on the network, and may be a MAC address or the like. The IP address is an example of destination information indicating a transmission destination of data.

The upload-use page URL is information used by the user terminal 35 for requesting HTML data of the upload-use page 33. The upload-use page URL is requested, for example, by using the HTTP GET method. For example, the upload-use page 33 is an area for uploading the document/image data 52 (e.g., target data) to be printed by the information processing apparatus 20. The user terminal 35 uploads the document/image data 52 to the area corresponding to the upload-use page URL to output the document/image data 52. The upload-use page URL is an example of the output destination information indicating an output destination of the target data transmitted from the external terminal such as the user terminal 35.

The URL for data transmission is information used for transmitting the document/image data 52 uploaded to the upload-use page 33 to the information processing apparatus 20 and requesting the printing of the target data to the information processing apparatus 20. The URL for data transmission is associated with the upload-use page 33. The URL for data transmission is requested, for example, by using the HTTP POST method.

As above described, the upload-use page URL and the URL for data transmission are uniquely assigned to each of the information processing apparatuses 20 so that the same upload-use page URL and the same URL for data transmission are not assigned to a plurality of the information processing apparatuses 20. That is, when the control apparatus 10 receives an HTTP request from, for example, the administrator terminal 30 or the user terminal 35 using the upload-use page URL, the IP address of the corresponding information processing apparatus 20 is uniquely determined. Therefore, based on the URL of the upload-use page 33 included in the connection information 21 read by the user terminal 35, the user terminal 35 can upload the target data, and can easily transmit the target data to the to-be-used specific information processing apparatus 20.

Referring to FIG. 7 again, the description of the functional configuration of the control apparatus 10 is continued. The storing/reading unit 153 stores various data in the storage unit 154, and reads various data from the storage unit 154. The storing/reading unit 153 and the storage unit 154 are implemented by, for example, the ROM 102, the storage 104, and executing programs using the CPU 101 of the control apparatus 10 illustrated in FIG. 4. The storage unit 154 stores the apparatus list 50 illustrated in FIG. 8. The storage unit 154 is an example of the storage unit.

The generation unit 155 generates the connection information 21 based on a request for generating the connection information 21 from the administrator terminal 30 or the information processing apparatus 20. The generation unit 155 serves as the connection information generation function 12 (FIG. 1). The generation unit 155 generates the connection information 21 based on the apparatus information 51 illustrated in FIG. 8. The connection information 21 includes, for example, the output destination information indicating the output destination of data assigned to each of the information processing apparatuses 20. The connection information 21 includes, for example, a URL of the upload-use page 33a for uploading the document/image data 52a such as the target data to be printed using the information processing apparatus 20a. The generation unit 155 is implemented by, for example, executing programs using the CPU 101 of the control apparatus 10 illustrated in FIG. 4. The generation unit 155 is an example of the generation unit.

The identification unit 156 identifies the information processing apparatus 20, which serves as a transmission destination of the target data output from an external terminal such as the administrator terminal 30 or the user terminal 35, based on the pre-set condition uniquely set for each of the information processing apparatuses 20, which means the pre-set conditions set for the information processing apparatuses 20 are different among the information processing apparatuses 20. Specifically, the identification unit 156 identifies the information processing apparatus 20, associated with the URL of the upload-use page 33 where the target data is uploaded from the user terminal 35, as the specific information processing apparatus 20 serving as the transmission destination of the target data. The identification unit 156 is implemented by, for example, executing programs using the CPU 101 of the control apparatus 10 illustrated in FIG. 4.

The second transmission/reception unit 157 has a function of transmitting and receiving data to and from the information processing apparatus 20. The second transmission/reception unit 157 serves as the data transmission function 13 (FIG. 1). The second transmission/reception unit 157 transmits the target data received by the first transmission/reception unit 151 to the information processing apparatus 20 identified by the identification unit 156. The second transmission/reception unit 157 transmits the document/image data 52 to the specific information processing apparatus 20 using the IP address illustrated in FIG. 8.

The second transmission/reception unit 157 transmits data to the information processing apparatus 20, and receives data from the information processing apparatus 20 using protocols such as file transfer protocol (FTP), hypertext transfer protocol (HTTP), hypertext transfer protocol secure (HTTPS), or line printer daemon (LPD). The second transmission/reception unit 157 is implemented by, for example, the communication unit 106 and executing programs using the CPU 101 of the control apparatus 10 illustrated in FIG. 4. The second transmission/reception unit 157 is an example of the transmission unit.

Hereinafter, a description is given of a functional configuration of the information processing apparatus 20 with reference to FIG. 7. As illustrated in FIG. 7, the functions implemented by the information processing apparatus 20 includes, for example, a first transmission/reception unit 251, an information processing unit 252, an apparatus information communication unit 253, a storing/reading unit 254, and a storage unit 255.

The first transmission/reception unit 251 transmits data to the control apparatus 10, and receives data from the control apparatus 10. The first transmission/reception unit 251 receives, for example, the document/image data 52 transmitted from the control apparatus 10. Further, the first transmission/reception unit 251 receives the connection information 21 transmitted from the control apparatus 10. The first transmission/reception unit 251 transmits data to the control apparatus 10, and receives data from the control apparatus 10 using protocols such as FTP, HTTP, HTTPS, or LPD. The first transmission/reception unit 151 is implemented by, for example, the communication unit 206 and executing programs using the CPU 201 of the information processing apparatus 20 illustrated in FIG. 5.

The information processing unit 252 performs printing of the document/image data 52 transmitted from the control apparatus 10. The information processing unit 252 serves as the information processing function 22 (FIG. 1). The information processing unit 252 is implemented by, for example, executing programs using the CPU 201 of the information processing apparatus 20 illustrated in FIG. 5.

The apparatus information communication unit 253 communicates the apparatus information 51 (see FIG. 8) with the control apparatus 10. The apparatus information communication unit 253 is implemented by the communication unit 206 and executing programs using the CPU 201 of the information processing apparatus 20 illustrated in FIG. 5.

The storing/reading unit 254 stores various data in the storage unit 255, and reads various data from the storage unit 255. The storing/reading unit 254 and the storage unit 255 are implemented by, for example, the flash memory 203, the HDD 204, and executing programs using the CPU 201 illustrated in FIG. 5. The storage unit 255 stores the apparatus information 51 illustrated in FIG. 8.

Hereinafter, a description is given of the functional configuration of the administrator terminal 30 with reference to FIG. 7. As illustrated in FIG. 7, the functions implemented by the administrator terminal 30 includes, for example, a first transmission/reception unit 351a, a display control unit 352a, a reading unit 353a, a data processing unit 354a, a storing/reading unit 355a, and a storage unit 356a.

The first transmission/reception unit 351a transmits data to the control apparatus 10, and receives data from the control apparatus 10. The first transmission/reception unit 351a serves as the browser function 32a (FIG. 1). For example, the first transmission/reception unit 351a transmits the target data uploaded to the upload-use page 33 to the control apparatus 10. The first transmission/reception unit 351a is implemented by, for example, the communication unit 309 and executing programs using the CPU 301 of the administrator terminal 30 illustrated in FIG. 6.

The display control unit 352a displays the connection information 21, received by the first transmission/reception unit 351a, using the display unit 306. The display control unit 352a is implemented by, for example, executing programs using the CPU 301 of the administrator terminal 30 illustrated in FIG. 6.

The reading unit 353a reads the connection information 21. The reading unit 353a serves as the reading function 31a (FIG. 1). When the connection information 21 is a two-dimensional code such as a QR code (registered trademark), the reading unit 353a reads the connection information 21 by capturing an image of the connection information. 21. The reading unit 353a is implemented by, for example, the camera unit 310 and executing programs using the CPU 301 of the administrator terminal 30 illustrated in FIG. 6.

If the connection information 21 is a short-range wireless communication signal such as the near field communication (NFC) signal, the reading unit 353a receives the connection information 21 using the short-range wireless communication. In this case, the reading unit 353a is implemented by, for example, the communication unit 309 and executing programs using the CPU 301 of the administrator terminal 30 illustrated in FIG. 6.

The data processing unit 354a outputs the document/image data 52a to the area, which is the output destination of data, based on the output destination information included in the connection information 21 read by the reading unit 353a. For example, the data processing unit 354a uploads the document/image data 52 to the area associated with the URL (i.e., upload-use page 33) based on the URL of the upload-use page 33 included in the connection information 21. The data processing unit 354a is implemented by, for example, executing programs using the CPU 301 of the administrator terminal 30 illustrated in FIG. 6.

The storing/reading unit 355a stores various data in the storage unit 356a, and reads various data from the storage unit 356a. The storing/reading unit 355a and the storage unit 356a are implemented by, for example, the ROM 302, the storage 304, and executing programs using the CPU 301 illustrated in FIG. 6. The storage unit 356a stores the document/image data 52a. The document/image data 52a is the target data to be printed by the information processing apparatus 20, which is output from the external terminal such as the user terminal 35.

Hereinafter, a description is given of a functional configuration of the user terminal 35 with reference to FIG. 7. As illustrated in FIG. 7, the functions implemented by the user terminal 35 includes, for example, a first transmission/reception unit 351b, a display control unit 352b, a reading unit 353b, a data processing unit 354b, a storing/reading unit 355b, and a storage unit 356b. The functions of the first transmission/reception unit 351b, the display control unit 352b, the reading unit 353b, the data processing unit 354b, the storing/reading unit 355b, the storage unit 356b are similar to the functions of the first transmission/reception unit 351a, the display control unit 352a, the reading unit 353a, the data processing unit 354a, the storing/reading unit 355a, and the storage unit 356a of the administrator terminal 30.

### Generation of Connection Information:

Hereinafter, a description is given of a processing of generating the connection information 21 in the control apparatus 10 of the first embodiment with reference to FIG. 9. FIG. 9 illustrates an example of a sequence diagram of a process of acquiring the apparatus information in the information processing control system 1 of the first embodiment. FIG. 9 illustrates an example case that the control apparatus 10 transmits an information acquisition request such as a discovery request to the information processing apparatus 20. FIG. 9 illustrates the example case that the control apparatus 10 acquires the apparatus information 51a from the information processing apparatus 20a, but the sequence illustrated in FIG. 9 is similarly performed for any information processing apparatus 20 (e.g., information processing apparatus 20b) connected to the control apparatus 10.

In step S101, the acquisition unit 152 of the control apparatus 10 transmits a request for acquiring the apparatus information 51 to the information processing apparatus 20a. The acquisition unit 152 of the control apparatus 10 transmits the request for acquiring the apparatus information 51 to the information processing apparatus 20 connected to or communicable with the control apparatus 10 via the network.

In step S102, after the apparatus information communication unit 253 of the information processing apparatus 20a receives the request for acquiring the apparatus information, the apparatus information communication unit 253 of the information processing apparatus 20a reads the apparatus information 51a. Specifically, the apparatus information communication unit 253 outputs a reading request for reading the apparatus information 51a to the storing/reading unit 254. After the storing/reading unit 254 detects the reading request output from the apparatus information communication unit 253, the storing/reading unit 254 reads the apparatus information 51a stored in the storage unit 255.

In step S103, the storage unit 255 of the information processing apparatus 20a outputs the apparatus information 51a to the apparatus information communication unit 253. Specifically, the storage unit 255 outputs the apparatus information 51a to the storing/reading unit 254. Then, the storing/reading unit 254 outputs the apparatus information 51a to the apparatus information communication unit 253.

In step S104, the apparatus information communication unit 253 of the information processing apparatus 20a transmits the apparatus information 51a, output from the storage unit 255, to the control apparatus 10. The apparatus information 51a transmitted from the apparatus information communication unit 253 is, for example, an IP address of the information processing apparatus 20a.

In step S105, the acquisition unit 152 of the control apparatus 10 generates the apparatus list 50 based on the apparatus information 51a received from the information processing apparatus 20a as illustrated in FIG. 8.

For example, the acquisition unit 152 associates the IP address of the information processing apparatus 20a, corresponding to the received apparatus information 51a, with the apparatus name, the upload-use page URL, and the URL for data transmission to generate the apparatus list 50. The apparatus name, the upload-use page URL, and the URL for data transmission can be set, for example, by the control apparatus 10. Further, the apparatus name, the upload-use page URL, and the URL for data transmission can be set by the information processing apparatus 20, and then transmitted to the control apparatus 10 together with the apparatus information 51.

In step S106, the acquisition unit 152 of the control apparatus 10 stores the generated apparatus list 50 in the storage unit 154. Specifically, the acquisition unit 152 outputs the generated apparatus list 50 to the storing/reading unit 153. Then, after the storing/reading unit 153 detects the apparatus list 50 output from the acquisition unit 152, the storing/reading unit 153 stores the apparatus list 50 in the storage unit 154. With this configuration, the control apparatus 10 can store the apparatus information 51 of one or more of the information processing apparatuses 20 connected to the control apparatus 10 via the network.

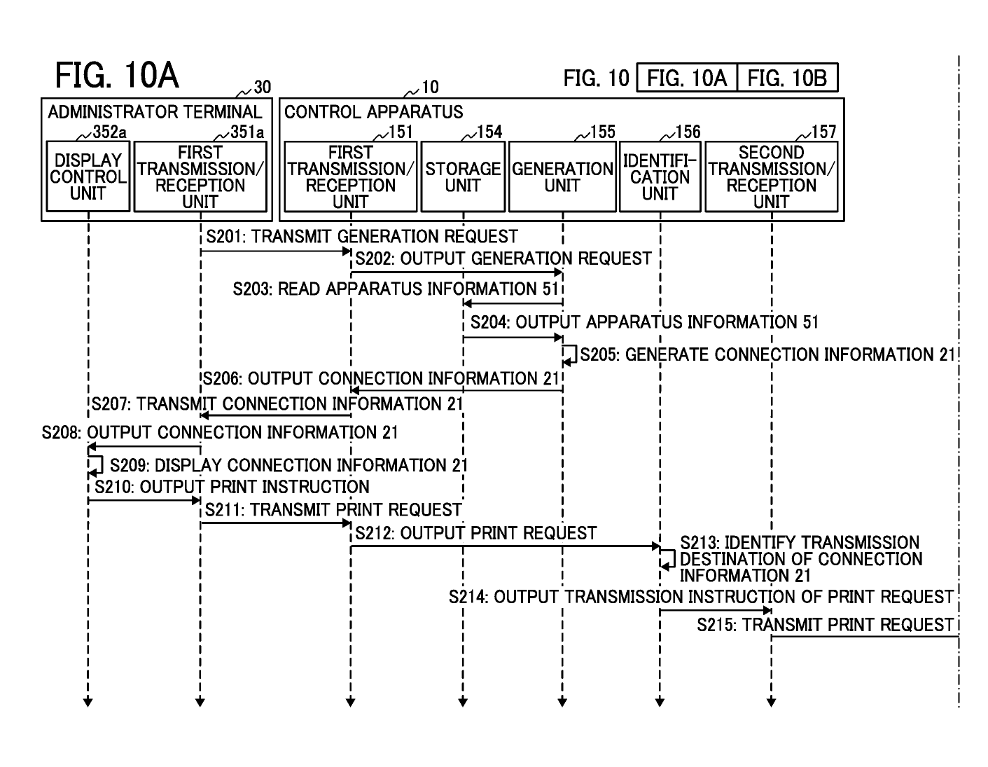

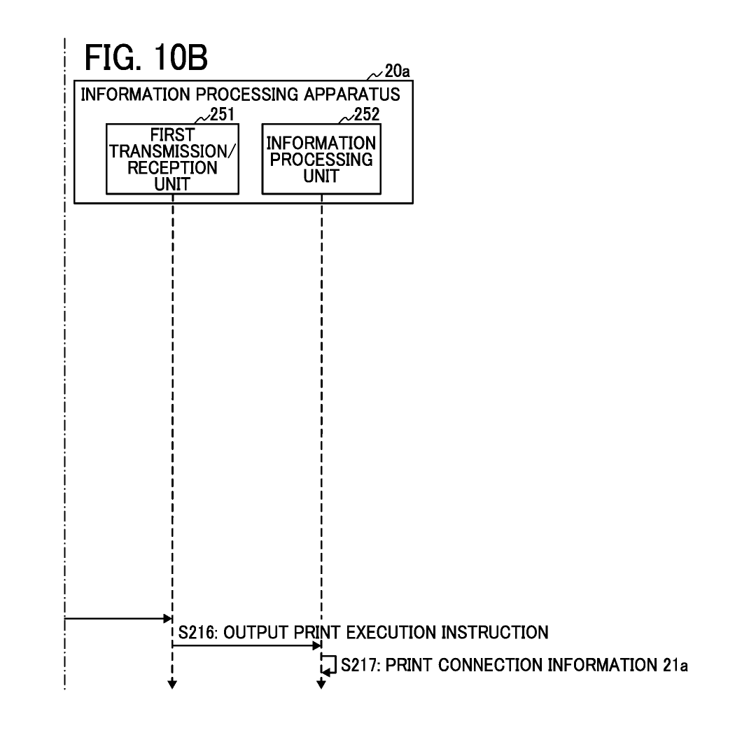

Hereinafter, a description is given of a process of generating the connection information 21 based on the apparatus information 51 stored in the control apparatus 10 with reference to FIG. 10. FIG. 10 (10A, 10B) illustrates an example of a sequence diagram of a process of generating the connection information 21 in the information processing control system 1 of the first embodiment. In FIG. 10, a request for generating the connection information 21 is transmitted to the control apparatus 10 from the administrator terminal 30, but the request for generating the connection information 21 can be transmitted from the user terminal 35.

In step S201, the first transmission/reception unit 351a of the administrator terminal 30 transmits a request for generating the connection information 21 to the control apparatus 10. Specifically, for example, the first transmission/reception unit 351a of the administrator terminal 30 transmits a request for generating the connection information 21 to the control apparatus 10 using a HTTP request (e.g., GET http://192.168.0.2/2d_code). Further, the first transmission/reception unit 151 of the control apparatus 10, operated as the HTTP server, receives a transmission request of the connection information 21 from the first transmission/reception unit 351a of the administrator terminal 30.

In step S202, the first transmission/reception unit 151 of the control apparatus 10 outputs the received request for generating the connection information 21 to the generation unit 155.

In step S203, after the generation unit 155 of the control apparatus 10 detects the request for generating the connection information 21 output from the first transmission/reception unit 151, the generation unit 155 reads the apparatus information 51 from the storage unit 154. Specifically, the generation unit 155 outputs a reading request for reading the apparatus information 51 to the storing/reading unit 153. After the storing/reading unit 153 detects the reading request, the storing/reading unit 153 reads the apparatus information 51 stored in the storage unit 154.

In step S204, the storage unit 154 of the control apparatus 10 outputs the apparatus information 51 to the generation unit 155. Specifically, the storage unit 154 outputs the apparatus information 51 to the storing/reading unit 153. Then, the storing/reading unit 153 outputs the apparatus information 51 to the generation unit 155.

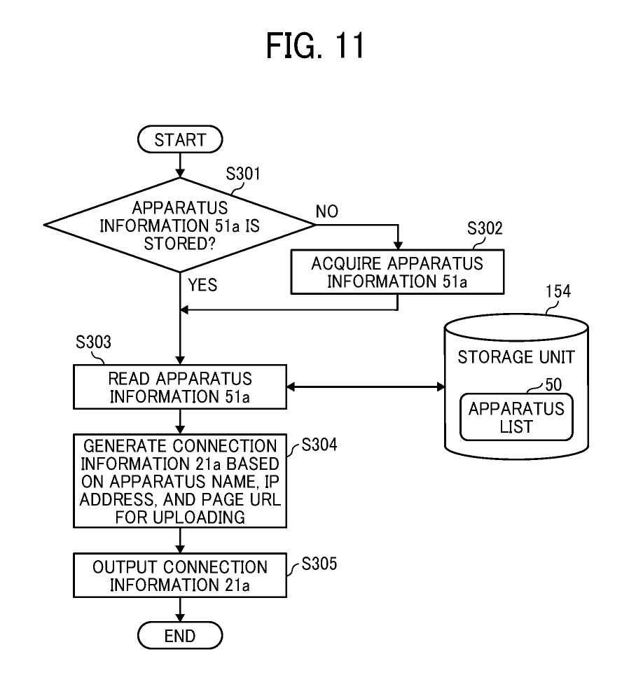

In step S205, after the generation unit 155 of the control apparatus 10 detects the apparatus information 51, the generation unit 155 generates the connection information 21. Hereinafter, a description is given of a detail of the processing by the generation unit 155 of the control apparatus 10 with reference to FIG. 11. FIG. 11 illustrates an example of a flowchart illustrating the steps of processing of the generation unit 155 of the first embodiment. FIG. 11 illustrates an example of generating the connection information 21a of the information processing apparatus 20a, but the connection information 21b of the information processing apparatus 20b can be also generated using the sequence of FIG. 11.

In step S301, the control apparatus 10 determines whether the apparatus information 51a is stored in the storage unit 154. If the apparatus information 51a is stored in the storage unit 154 (S301: YES), the control apparatus 10 proceeds the sequence to step S303. On the other hand, if the apparatus information 51a is not stored in the storage unit 154 (S301: NO), the control apparatus 10 proceeds the sequence to step S302.

In step S302, the control apparatus 10 acquires the apparatus information 51a from the information processing apparatus 20a. The acquisition process of the apparatus information 51a is same as the sequence of FIG. 9.

In step S303, the control apparatus 10 reads the apparatus information 51a from the apparatus list 50 stored in the storage unit 154.

In step S304, the control apparatus 10 generates the connection information 21a of the information processing apparatus 20a using the read apparatus information 51a. Specifically, the control apparatus 10 processes the URL of the upload-use page 33a included in the apparatus information 51a (FIG. 8) to generate the connection information 21a as a two-dimensional code.

In step S305, the control apparatus 10 outputs the generated connection information 21a.

Referring to FIG. 10 again, the description of the process of generating the connection information 21 in the information processing control system 1 is continued.

In step S206, the generation unit 155 of the control apparatus 10 outputs the generated connection information 21 to the first transmission/reception unit 151.

In step S207, the first transmission/reception unit 151 of the control apparatus 10 transmits the connection information 21 to the administrator terminal 30. Specifically, the first transmission/reception unit 151 of the control apparatus 10, operated as the HTTP server, transmits the generated connection information 21 to the administrator terminal 30.

In step S208, the first transmission/reception unit 351a of the administrator terminal 30 outputs the received connection information 21 to the display control unit 352a.

In step S209, after the display control unit 352a of the administrator terminal 30 detects the connection information 21, the display control unit 352a uses the browser function 32a to display the connection information 21.

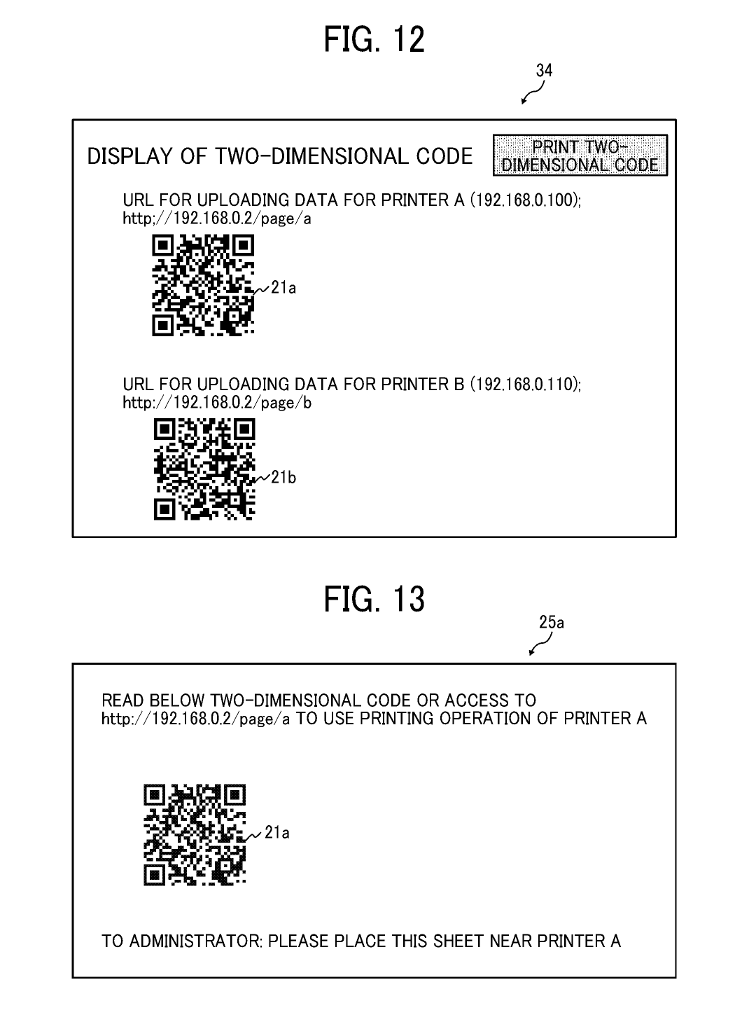

Hereinafter, a description is given of a display image displayed by using the browser function 32a with reference to FIG. 12. FIG. 12 illustrates an example of a display image 34 displayed on the administrator terminal 30 of the first embodiment. The display image 34 illustrated in FIG. 12 includes, for example, the connection information 21a corresponding to the information processing apparatus 20a, and the connection information 21b corresponding to information processing apparatus 20b.

The display image 34 includes, for example, a message of URL for uploading data such as “http://192.168.0.2/page/a” corresponding to the information processing apparatus 20a, embedded in the two-dimensional code as the connection information 21a. Further, the display image 34 includes, for example, a message of the IP address “192.168.0.100” of the information processing apparatus 20a. Similarly, information regarding the information processing apparatus 20b is also included in the display image 34.

Further, the display image 34 includes, for example, an icon indicating “print two-dimensional code” for requesting printing of the connection information 21, which is the two-dimensional code. When the “print two-dimensional code” icon is selected by a user, the administrator terminal 30 transmits a print request of the connection information 21 to the control apparatus 10.

As above described, by displaying the connection information 21 on the administrator terminal 30, the administrator using the administrator terminal 30 can check the contents of the connection information 21 before the connection information 21 is printed. The display image 34 of the connection information 21 illustrated in FIG. 12 is just one example, and not limited thereto. Further, FIG. 12 illustrates an example of displaying the connection information 21 of two information processing apparatuses 20 such as the information processing apparatuses 20a and 20b, but the number of displayed connection information 21 can be changed in accordance with the number of the information processing apparatuses 20 connected to the control apparatus 10 via the network.

Referring to FIG. 10 again, the description of the process of generating the connection information 21 in the information processing control system is continued.

In step S210, the display control unit 352a of the administrator terminal 30 outputs a print instruction of the connection information 21 to the first transmission/reception unit 351a. Specifically, after the display control unit 352a detects that the icon of “print the two-dimensional code” of the display screen illustrated in FIG. 12 is selected (e.g., pressed) by the user, the display control unit 352a outputs the print instruction of the connection information 21 to the first transmission/reception unit 351a.

In step S211, after the first transmission/reception unit 351a of the administrator terminal 30 detects the print instruction of the connection information 21 output from the display control unit 352a, the first transmission/reception unit 351a transmits the print request of the connection information 21 to the control apparatus 10. Specifically, the first transmission/reception unit 351a of the administrator terminal 30 transmits, for example, the print request of the connection information 21 to the HTTP request (e.g., POST http://192.168.0.2/2d_code/print).

In step S212, the first transmission/reception unit 151 of the control apparatus 10 outputs the print request of the received connection information 21 to the identification unit 156.

In step S213, after the identification unit 156 of the control apparatus 10 detects the print request of the connection information 21, the identification unit 156 identifies the information processing apparatus 20 to be transmitted with the connection information 21.

Specifically, the identification unit 156 identifies the information processing apparatus 20 associated with the URL of the upload-use page 33 included in the connection information 21 as the transmission destination of the connection information 21. In the example illustrated in FIG. 10, the connection information 21 includes, for example, the URL of the upload-use page 33a corresponding to the information processing apparatus 20a, and the identification unit 156 identifies the information processing apparatus 20a as the transmission destination of the connection information 21.

In step S214, the identification unit 156 of the control apparatus 10 identifies the information processing apparatus 20a as the transmission destination of the connection information 21, and then outputs a transmission instruction of the print request of the connection information 21 to the second transmission/reception unit 157.

In step S215, after the second transmission/reception unit 157 of the control apparatus 10 detects the transmission instruction of the print request of the connection information 21a, the second transmission/reception unit 157 transmits the print request of the connection information 21a to the information processing apparatus 20a. Specifically, the first transmission/reception unit 151 of the control apparatus 10, operated as the HTTP server, transmits the print request of the connection information 21a to the IP address of the information processing apparatus 20a corresponding to the connection information 21a. In step S216, after the first transmission/reception unit 251 of the information processing apparatus 20a receives the print request of the connection information 21a, the first transmission/reception unit 251 outputs a print execution instruction of the connection information 21a to the information processing unit 252.

In step S217, after the information processing unit 252 of the information processing apparatus 20a detects the print execution instruction of the connection information 21a, the information processing unit 252 of the information processing apparatus 20a performs the printing of the connection information 21a.

Hereinafter, a description is given of a print image of the connection information 21a with reference to FIG. 13. FIG. 13 illustrates an example of the connection information 21 printed by the information processing apparatus 20 of the first embodiment. FIG. 13 illustrates an example of a print image 25a output from the information processing apparatus 20a when the connection information 21a corresponding to the information processing apparatus 20a is printed.

As illustrated in FIG. 13, the print image 25a includes the connection information 21a as the two-dimensional code. Further, the print image 25a includes a message to a user who wants to use the information processing apparatus 20a, such as “read two-dimensional code or access to http://192.168.0.2/page/a to perform a printing operation using printer A.” Further, the print image 25a includes a message to an administrator of the information processing control system 1, such as “to administrator: please place this sheet near printer A.”

For example, the sheet printed with the print image 25a is attached to the housing of the information processing apparatus 20a, or placed beside the information processing apparatus 20a so that the user who wants to use the information processing apparatus 20a can determine the relationship of the information processing apparatus 20a and the print image 25a including the connection information 21a. With this configuration, the user who wants to use the information processing apparatus 20a can use the information processing apparatus 20a by reading the connection information 21a corresponding to the information processing apparatus 20a using the user terminal 35.

It should be noted that the print image 25a illustrated in FIG. 13 is not limited thereto. The print image 25a includes at least the connection information 21a. Further, FIG. 13 illustrates the print image 25a of the connection information 21a corresponding to the information processing apparatus 20a, and the connection information 21b corresponding to the information processing apparatus 20b can be similarly output as a print image.

### Printing of Data:

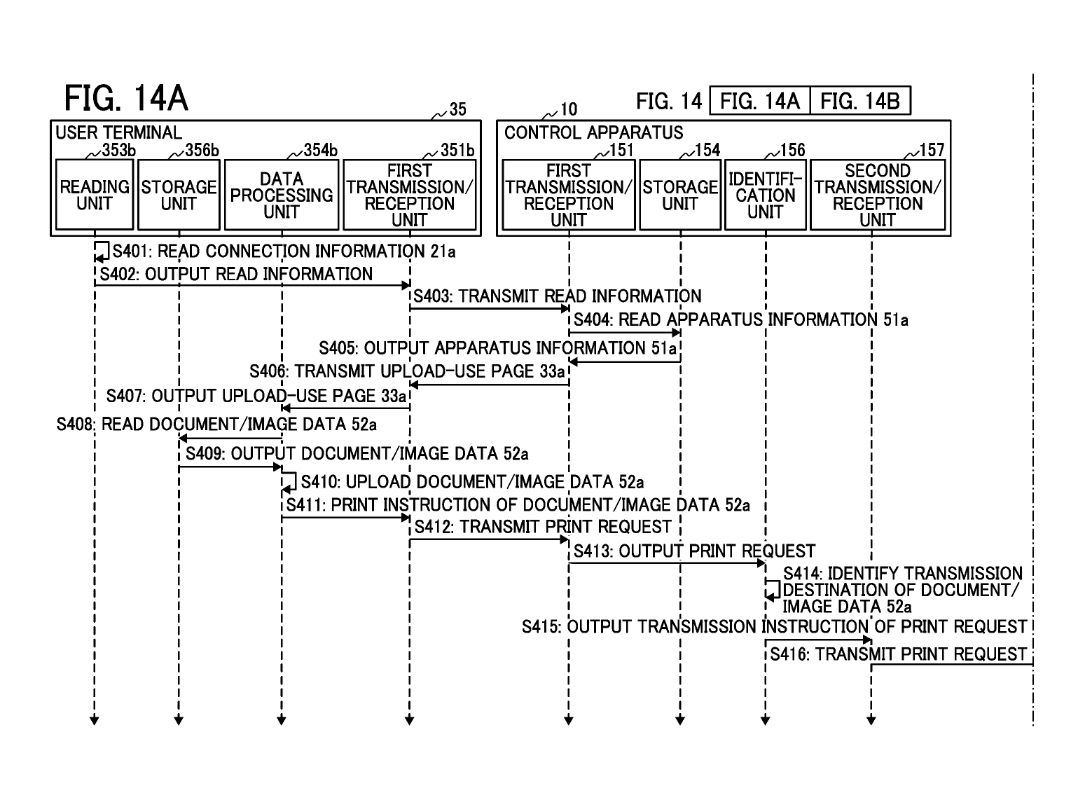

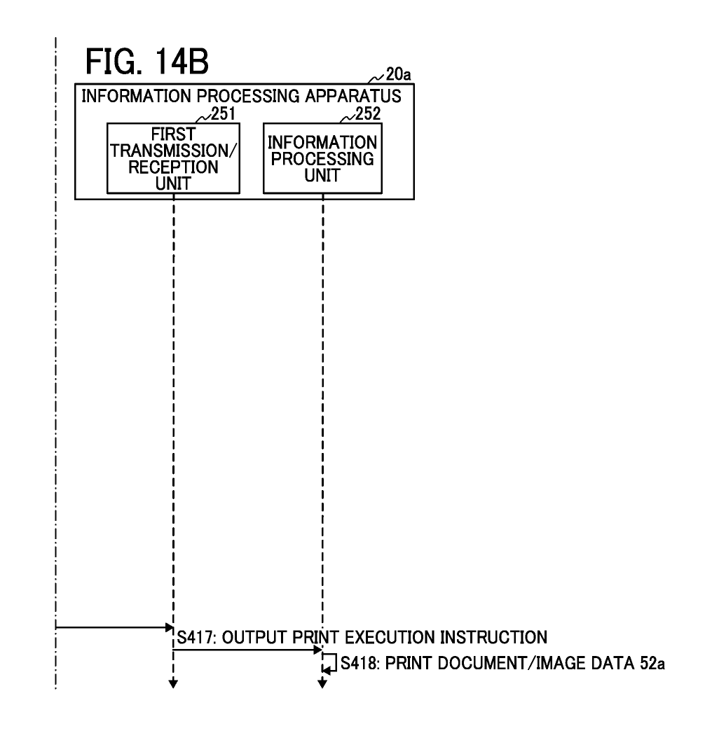

Hereinafter, a description is given of a process of printing data output from the user terminal 35 that has read the connection information 21, using the information processing apparatus 20 with reference to FIG. 14 (14A, 14B). FIG. 14 illustrates an example of a sequence diagram of a printing process in the information processing control system 1 of the first embodiment. FIG. 14 illustrates an example case that the user terminal 35 transmits a print request of the target data to the information processing apparatus 20a, and this sequence is similarly applied for transmitting the print request of the target data from the user terminal 35 to the information processing apparatus 20b. Further, FIG. 14 describes an example case that the user terminal 35 transmits the print request of the target data to the information processing apparatus 20, but the print request of the target data to the information processing apparatus 20 can be transmitted from the administrator terminal 30.

In step S401, the reading unit 353b of the user terminal 35 reads the connection information 21a. Specifically, the reading unit 353b reads the connection information 21a, which is the two-dimensional code, by capturing an image of the connection information 21a included in the print image 25a printed on the sheet (FIG. 13).

In step S402, the reading unit 353b of the user terminal 35 decodes the upload-use page URL included in the read connection information 21a, and outputs the read information to the first transmission/reception unit 351b. In this example case, the read information is “http://192.168.0.2/page/a” illustrated in FIG. 8.

In step S403, the first transmission/reception unit 351b of the user terminal 35 transmits the read information to the control apparatus 10. Specifically, the first transmission/reception unit 315b of the user terminal 35 requests HTML data of the upload-use page 33 to the control apparatus 10, for example, using the decoded upload-use page URL (i.e. read information) with the HTTP request. The first transmission/reception unit 151 of the control apparatus 10, operated as the HTTP, receives the request of the HTML data of the upload-use page 33 from the user terminal 35.

In step S404, after the first transmission/reception unit 151 of the control apparatus 10 receives the read information, the first transmission/reception unit 151 reads the apparatus information 51a from the storage unit 154. Specifically, the first transmission/reception unit 151 outputs a reading request for reading the upload-use page 33a included in the apparatus information 51a to the storing/reading unit 153. After the storing/reading unit 153 detects the reading request, the storing/reading unit 153 reads the upload-use page 33a included in the apparatus information 51a stored in the storage unit 154.

In step S405, the storage unit 154 of the control apparatus 10 outputs the apparatus information 51a to the first transmission/reception unit 151. Specifically, the storage unit 154 outputs the upload-use page 33a included in the apparatus information 51a to the storing/reading unit 153. Then, the storing/reading unit 153 outputs the upload-use page 33a included in the apparatus information 51a to the first transmission/reception unit 151.

In step S406, the first transmission/reception unit 151 of the control apparatus 10 transmits the upload-use page 33a to the user terminal 35. Specifically, the first transmission/reception unit 151 of the control apparatus 10, operated as the HTTP server, transmits the upload-use page 33a to the first transmission/reception unit 351b of the user terminal 35 serving as the browser function 32a.

In step S407, the first transmission/reception unit 351b of the user terminal 35 outputs the received upload-use page 33a to the data processing unit 354b. Specifically, the first transmission/reception unit 351b of the user terminal 35 reads the received upload-use page 33a using the browser function 32a to output the received upload-use page 33a as data that can be processed by the data processing unit 354b.

In step S408, after the data processing unit 354b of the user terminal 35 detects the upload-use page 33a output from the first transmission/reception unit 351b, the data processing unit 354b reads the document/image data 52a from the storage unit 356b. Specifically, the data processing unit 354b outputs a reading request for reading the document/image data 52a to the storing/reading unit 355b. After the storing/reading unit 355b detects the reading request, the storing/reading unit 355b reads the document/image data 52a stored in the storage unit 356b. The data read by the data processing unit 354b is not limited to the document/image data 52a, but any data uploadable to the upload-use page 33 can be read by the data processing unit 354b.

In step S409, the storage unit 356b of the user terminal 35 outputs the document/image data 52a to the data processing unit 354b. Specifically, the storage unit 356b outputs the document/image data 52a to the storing/reading unit 355b. Then, the storing/reading unit 355b outputs the document/image data 52a to the data processing unit 354b.

In step S410, the data processing unit 354b of the user terminal 35 uploads the document/image data 52a to the upload-use page 33a, which is the area where the target data is output (i.e., output destination of data).

In step S411, the data processing unit 354b of the user terminal 35 outputs a print instruction of the uploaded document/image data 52a to the first transmission/reception unit 351b.

In step S412, the first transmission/reception unit 351b of the user terminal 35 transmits a print request of the document/image data 52a to the control apparatus 10. Specifically, the first transmission/reception unit 351b of the user terminal 35 transmits the document/image data 52a to the URL for data transmission such as “http://192.168.0.2/print/a” corresponding to the information processing apparatus 20a (see FIG. 8). Then, the first transmission/reception unit 151 of the control apparatus 10, operated as the HTTP server, receives the document/image data 52a transmitted to the URL for data transmission.

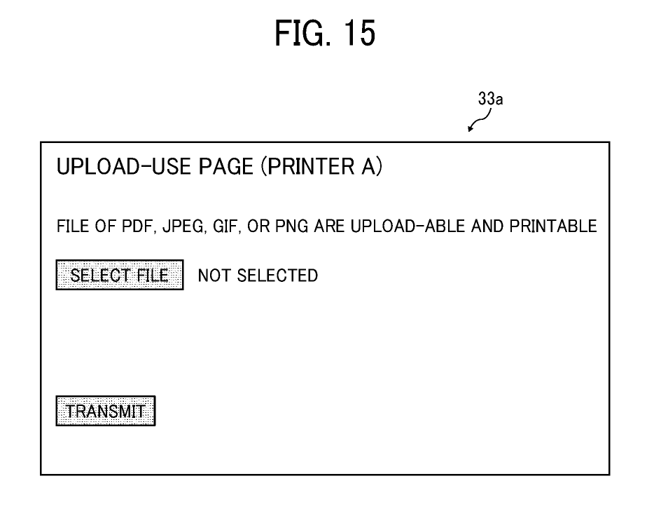

Hereinafter, a description is given of a detail of processing by the data processing unit 354b of the user terminal 35 with reference to FIG. 15. FIG. 15 illustrates an example of the upload-use page 33a of the first embodiment. The upload-use page 33a is used as a page for uploading to-be-printed target data using the information processing apparatus 20a.

The upload-use page 33a is displayed using the browser function 32b of the user terminal 35 after the user terminal 35 accesses the URL of the upload-use page 33a (e.g., http://192.168.0.2/page/a) included in the connection information 21a. The upload-use page 33a is an example of an area assigned to each of the information processing apparatuses 20 where the target data is output from the external terminal such as the user terminal 35. The URL of the upload-use page 33a is an example of the output destination information indicating the output destination of the target data from the external terminal such as the user terminal 35.

The upload-use page 33a illustrated in FIG. 15 indicates that the target data is not yet uploaded. The data processing unit 354b selects the target data to be uploaded when a user using the user terminal 35 selects an icon of “file selection.”

In this example case, as illustrated in FIG. 15, an upload-able data file format is, for example, portable document format (PDF), joint photographic experts group (JPEG), graphics interchange format (GIF), or portable network graphics (PNG). With this configuration, the control apparatus 10 that acquires the uploaded target data can omit a file conversion process when transmitting the target data to the information processing apparatus 20. The data file format that can be uploaded is not limited to thereto.

When an icon of “transmit” is selected by the user carrying the user terminal 35, the data processing unit 354b outputs the selected data to the first transmission/reception unit 351b. The upload-use page 33a illustrated in FIG. 15 is just one example, and the page layout and the like are not limited thereto. FIG. 15 illustrates the upload-use page 33a corresponding to the information processing apparatus 20a, but the upload-use page 33b corresponding to the information processing apparatus 20b may use the same configuration.

Referring to FIG. 14 again, the description of the printing process in the information processing control system 1 is continued.

In step S413, when the first transmission/reception unit 151 of the control apparatus 10 receives the print request of the document/image data 52a, the first transmission/reception unit 151 outputs the print request of the document/image data 52a to the identification unit 156.

In step S414, after the identification unit 156 of the control apparatus 10 detects the print request of the document/image data 52a output from the first transmission/reception unit 151, the identification unit 156 identifies the information processing apparatus 20 to be used as the transmission destination of the document/image data 52a. Since the document/image data 52a is corresponded to the information processing apparatus 20a in the apparatus list 50 (FIG. 8), the identification unit 526 identifies the information processing apparatus 20a as the transmission destination for the document/image data 52a.

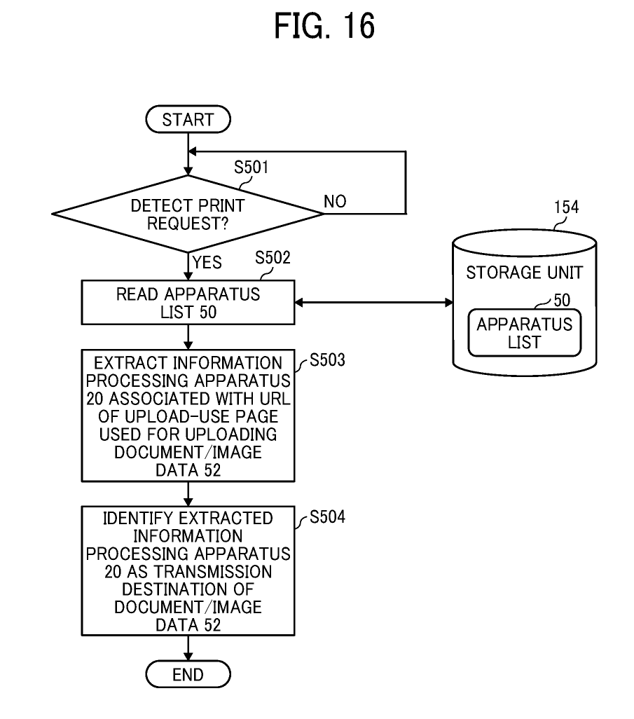

Hereinafter, a description is given of a detail of processing of the identification unit 156 with reference to FIG. 16. FIG. 16 illustrates an example of a flowchart illustrating the steps of processing of the identification unit 156 of the first embodiment.

In step S501, the identification unit 156 determines whether the identification unit 156 detects the print request of the document/image data 52. If the identification unit 156 detects the print request of the document/image data 52 (S501: YES), the sequence proceeds to step 502. On the other hand, if the identification unit 156 does not detect the print request of the document/image data 52 (S501: NO), the identification unit 156 repeats step 501 until the identification unit 156 detects the print request of the document/image data 52.

In step S502, the identification unit 156 reads the apparatus list 50 stored in the storage unit 154.

In step S503, the identification unit 156 extracts the information processing apparatus 20, associated with the URL of the upload-use page 33 used for uploading the document/image data 52, from the read apparatus list 50.

In step S504, the identification unit 156 identifies the extracted information processing apparatus 20 serving as the transmission destination of the document/image data 52. Since the URL of the upload-use page 33 differs for each of the information processing apparatuses 20, the identification unit 156 can uniquely identify the information processing apparatus 20 to be used as the transmission destination of the document/image data 52 based on the URL of the upload-use page 33 included in the apparatus list 50. The URL of the upload-use page 33 is an example of information that differs for each of the information processing apparatuses 20.

Referring to FIG. 14 again, the description of the printing process in the information processing control system 1 is continued.

In step S415, after the identification unit 156 of the control apparatus 10 identifies the information processing apparatus 20a as the transmission destination of the document/image data 52a, the identification unit 156 outputs a transmission instruction of a print request of the document/image data 52a to the second transmission/reception unit 157.

In step S416, after the second transmission/reception unit 157 of the control apparatus 10 detects the transmission instruction of the print request of the document/image data 52a, the second transmission/reception unit 157 transmits the print request of the document/image data 52a to the information processing apparatus 20a. Specifically, the second transmission/reception unit 157 of the control apparatus 10, operated as the HTTP server, transmits the document/image data 52a to the IP address “192.168.0.100” of the information processing apparatus 20a (see FIG. 8). Then, the first transmission/reception unit 251 of the information processing apparatus 20a receives the document/image data 52a using protocols such as FTP, HTTP, HTTPS, or LPD.

In step S417, after the first transmission/reception unit 251 of the information processing apparatus 20a receives the print request of the document/image data 52a, the first transmission/reception unit 251 outputs a print execution instruction of the document/image data 52a to the information processing unit 252.

In step S418, after the information processing unit 252 of the information processing apparatus 20a detects the print execution instruction of the document/image data 52a output from the first transmission/reception unit 251, the information processing unit 252 performs printing of the document/image data 52a. With this processing, the document/image data 52a stored in the user terminal 35 is printed by the information processing apparatus 20a.

As described above, in the information processing control system 1 of the first embodiment, the control apparatus 10 receives the document/image data 52 uploaded to the upload-use page 33 from the user terminal 35. Then, in the information processing control system 1, the control apparatus 10 identifies the information processing apparatus 20 corresponding to the upload-use page 33, uploaded with the received document/image data 52, as the transmission destination of the document/image data 52, and transmits the document/image data 52 to the identified information processing apparatus 20. Therefore, as to the information processing control system 1, the document/image data 52 output from the user terminal 35 can be easily transmitted to the specific information processing apparatus 20 without installing a dedicated software or application program in the user terminal 35.

### Variant Example 1 of First Embodiment

Hereinafter, a description is given of a variant example 1 of the first embodiment. As to an information processing control system 1a of the variant example 1 of the first embodiment, the URL of the upload-use page 33, to be uploaded with the document/image data 52, includes information identifying a destination of the information processing apparatus 20.

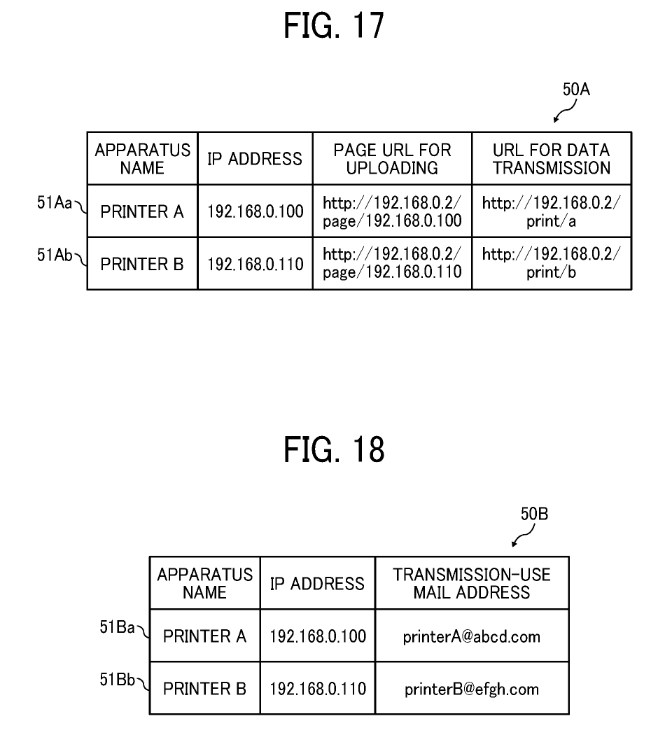

FIG. 17 illustrates an example of an apparatus list 50A of the variant example 1 of the first embodiment. Different from the apparatus list 50 illustrated in FIG. 8, the apparatus list 50A illustrated in FIG. 17 includes the IP address of the information processing apparatus 20 in the upload-use page URL. For example, the upload-use page URL of “http://192.168.0.2/page/192.168.0.100” set for the information processing apparatus 20a having the apparatus name of “Printer A” includes the IP address of the information processing apparatus 20a (i.e., 192.168.0.100). Further, the upload-use page URL of “http://192.168.0.2/page/192.168.0.110” set for the information processing apparatus 20b having the apparatus name of “Printer B” includes the IP address of the information processing apparatus 20b (i.e., 192.168.0.110).

With this configuration, in the information processing control system 1a, when the control apparatus 10 detects the print request, the control apparatus 10 can identify the information processing apparatus 20 based on the URL of the upload-use page 33 without referring to the apparatus list 50. Specifically, the information processing control system 1a can omit step S503 by the identification unit 156 in FIG. 16. The “apparatus name,” “IP address” and “URL for data transmission” in the apparatus list 50A illustrated in FIG. 17 are same as those illustrated in FIG. 8.

### Variant Example 2 of First Embodiment

Hereinafter, a description is given of a variant example 2 of the first embodiment. As to an information processing control system 1b of the variant example 2 of the first embodiment, the document/image data 52 output from the user terminal 35 is transmitted using an electronic mail format, such as simple mail transfer protocol (SMTP) instead of using a web browser.

FIG. 18 illustrates an example of an apparatus list 50B of the variant example 2 of the first embodiment. As illustrated in FIG. 18, the apparatus list 50 B includes a transmission-use mail address instead of the upload-use page URL and the URL for data transmission included in the apparatus list 50 illustrated in FIG. 8. The transmission-use mail address is, for example, an e-mail address indicating a destination such as the information processing apparatuses 20. The transmission-use mail address is assigned to each of the information processing apparatuses 20, which becomes the transmission destination of the document/image data 52. The transmission-use mail address is an example of the output destination information indicating the output destination of target data from the external terminal such as the user terminal 35.

For example, the control apparatus 10 is configured to include a plurality of reception folders, each set with each specific transmission-use mail address so that each mail address can be identified. The identification unit 156 of the control apparatus 10 identifies the specific information processing apparatus 20, corresponding to the specific transmission-use mail address to be transmitted with the mail, as the transmission destination of the document/image data 52.

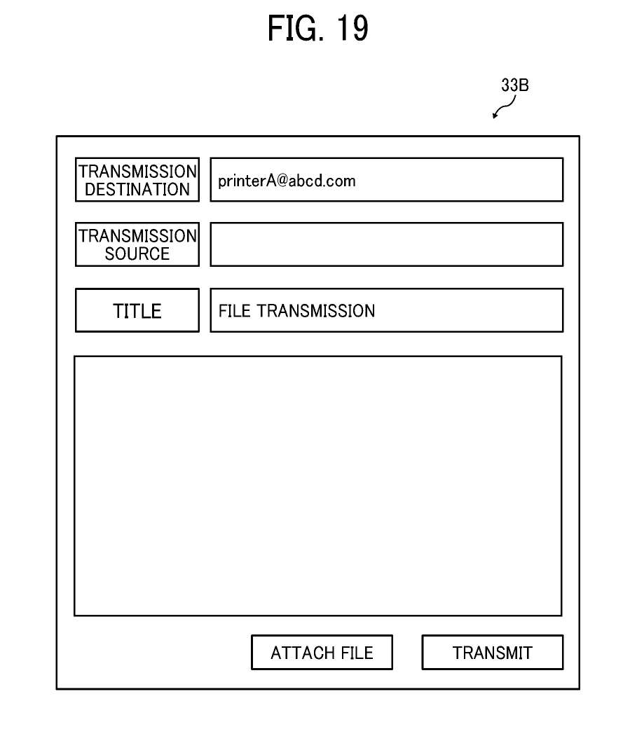

FIG. 19 is an example of a mail transmission screen 33B of the variant example 2 of the first embodiment. For example, the mail transmission screen 33B illustrated in FIG. 19 is displayed using the display unit 306 of the user terminal 35. When the user terminal 35 reads the connection information 21 including the transmission-use mail address illustrated in FIG. 18, the mail transmission screen 33B displaying the read transmission-use mail address is displayed as illustrated in FIG. 19.

The user terminal 35 attaches the to-be-transmitted document/image data 52 to the e-mail when a user selects an icon of the “attach file” illustrated in FIG. 19. When an icon of “transmit” illustrated in FIG. 19 is selected (e.g. pressed) by the user, the user terminal 35 transmits the attached document/image data 52 to the control apparatus 10.

As to the above described information processing control system 1b, the target data output from the user terminal 35 can be easily transmitted to the specific information processing apparatus 20 same as the first embodiment, by transmitting the e-mail attached with the document/image data 52 to the control apparatus 10 using the transmission-use mail address uniquely set for each of the information processing apparatuses 20.

### Variant Example 3 of First Embodiment

Hereinafter, a description is given of a variant example 3 of the first embodiment. As to an information processing control system 1c of the variant example 3 of the first embodiment, the connection information is transmitted and received using the short-range wireless communication, such as NFC, instead of the two-dimensional code such as the QR code (registered trademark).

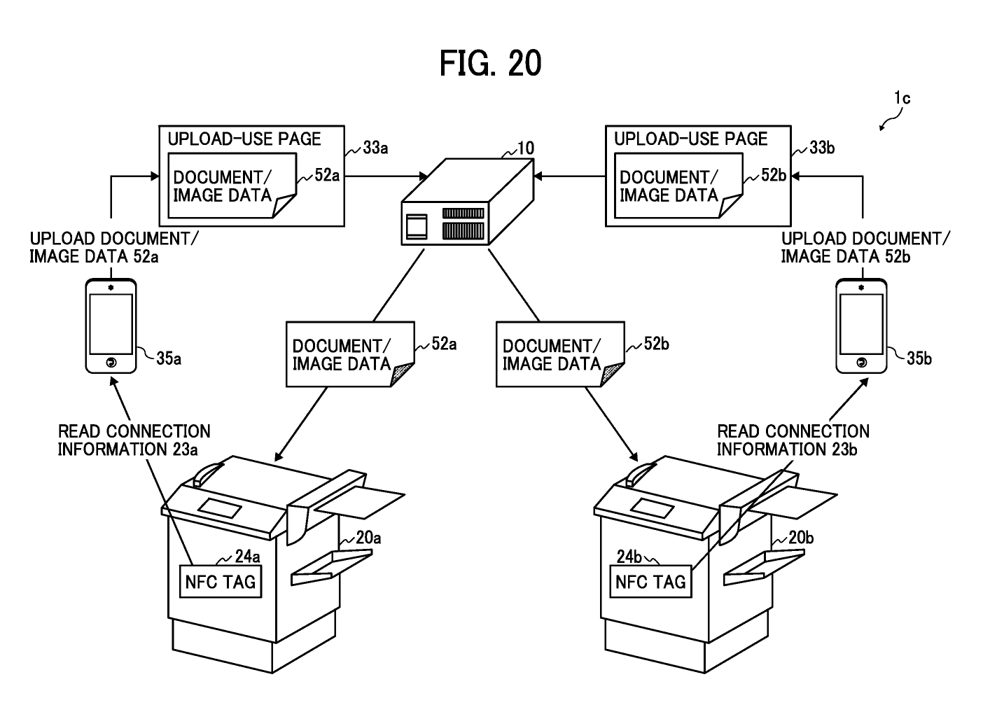

FIG. 20 illustrates an example of the information processing control system 1c of the variant example 3 of the first embodiment. In the information processing control system 1c, connection information 23 including the upload-use page URL is transmitted and received using the short-range wireless communication such as NFC communication.

The control apparatus 10 generates the connection information 23 using a data format that can be communicated using the NFC communication. The control apparatus 10 generates the connection information 23 using, for example, a format of NFC data exchange format (NDEF). The information included in the connection information 23 is same as the information included in the connection information 21.

In the variant example 3 of the first embodiment, the information processing apparatus 20 includes an NFC tag 24 having a reader/writer function capable of reading and writing information, which is transmitted and received using the NFC communication. The NFC tag 24 is attached to, for example, a housing of the information processing apparatus 20. The NFC tag 24 stores the connection information 23 generated by the control apparatus 10.

Since the user terminal 35 can communicate data using the NFC communication, the user terminal 35 can read the connection information 23 using the NFC communication. Then, the user terminal 35 transmits the document/image data 52 to the information processing apparatus 20 based on the upload-use page URL included in the read connection information 23.

As to the above described information processing control system 1c, the user terminal 35 can acquire the connection information 23 associated with the information processing apparatus 20 using the short-range wireless communication. With this configuration, the user terminal 35 can acquire the connection information 23 when the user carrying the user terminal 35 approaches the information processing apparatus 20, and the user terminal 35 can easily transmit the target data to the specific information processing apparatus 20 as similar to the first embodiment. Further, the short-range wireless communication for transmitting and receiving the connection information 23 is not limited to the NFC communication, but can be Bluetooth (registered trademark) or infrared ray.

### Second Embodiment

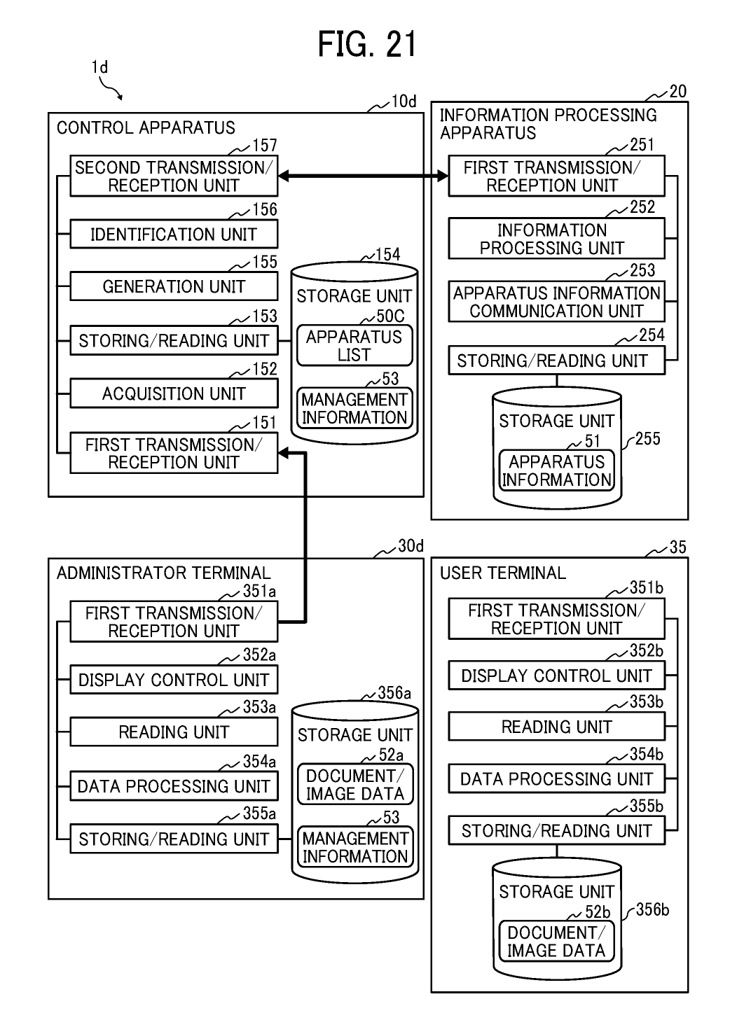

Hereinafter, a description is given of an information processing control system 1d of a second embodiment with reference to FIG. 21. In the information processing control system 1d of the second embodiment, a plurality of information processing apparatuses 20 is associated with the same upload-use page 33, in which the control apparatus 10d identifies at least one information processing apparatus 20 from the plurality of information processing apparatuses 20 to transmit the uploaded document/image data 52 to the identified one information processing apparatus 20.

### Functional Configuration:

FIG. 21 illustrates an example of a functional block diagram of the information processing control system 1d of the second embodiment. The same functions as those of the first embodiment are denoted by the same reference numerals, and descriptions thereof will be omitted. In addition to the functions of the first embodiment, as illustrated in FIG. 21, the control apparatus 10 stores apparatus list 50C and management information 53 in the storage unit 154.

In the second embodiment, the identification unit 156 of the control apparatus 10d identifies the information processing apparatus 20, to be used as the transmission destination of the document/image data 52 uploaded to the upload-use page 33, based on information of an operation time range set for each of the information processing apparatuses 20 included in the management information 53. Further, in the second embodiment, the administrator terminal 30d stores management information 53 in the storage unit 356a. The management information 53 stored in the storage unit 356a is similar to the management information 53 stored in the storage unit 154 of the control apparatus 10d. The management information 53 includes operation management information.

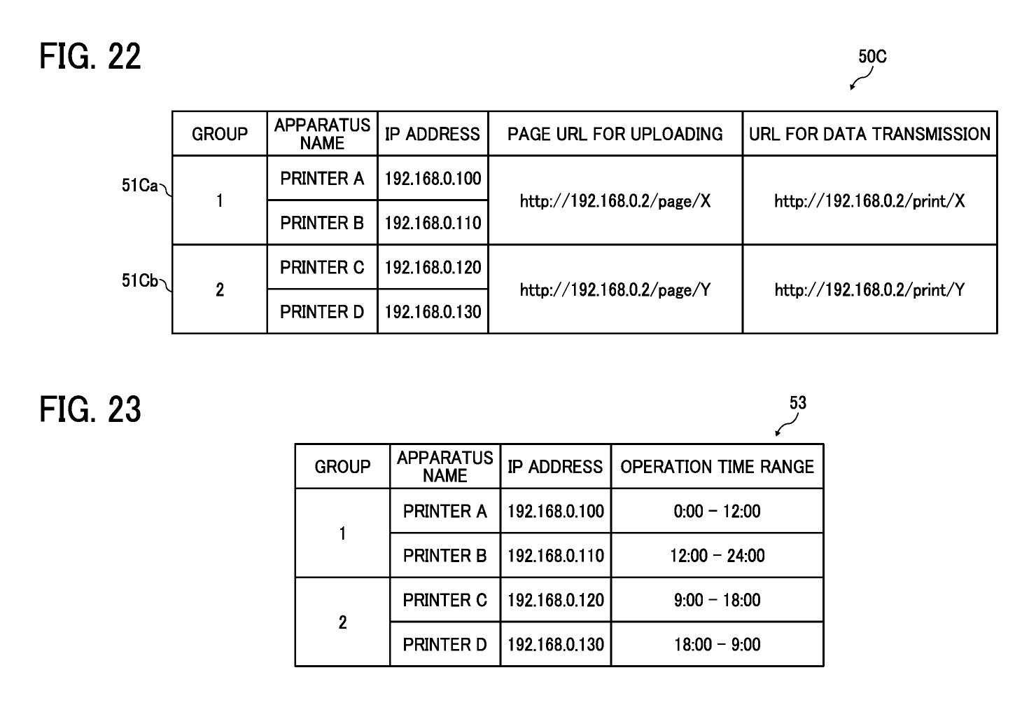

FIG. 22 illustrates an example of the apparatus list 50C of the second embodiment. As illustrated in FIG. 22, the apparatus list 50C includes information of a plurality of information processing apparatuses 20 by grouping and listing the information, in which two of more information processing apparatuses 20 belonging to the same group are set with the same upload-use page URL and the same URL for data transmission. For example, two of more information processing apparatuses 20 disposed in the same room can be grouped as the same group, and registered in the apparatus list 50C. The identification unit 156 of the control apparatus 10 extracts a group of the information processing apparatuses 20 associated with the same URL of the upload-use page 33 uploadable with the document/image data 52.

FIG. 23 illustrates an example of the management information 53 of the second embodiment. As illustrated in FIG. 23, the management information 53 includes an operation time range set for each of the information processing apparatuses 20. For example, a first group 1 includes printers A and B, in which the printer A can be used in a time range of “0:00 to 12:00 (AM),” and the printer B can be used in a time range of “12:00 to 24:00 (PM).” Further, a second group 2 includes printers C and D, in which the printer C can be used in a time range of “9:00 (AM)” and 18:00 (PM),” and the printer D can be used in a time range of “18:00 (PM) to 9:00 (AM).” The management information 53 is an example of operation conditions uniquely settable for each of the information processing apparatuses 20, in which the operation conditions set differently.

In the second embodiment, since the plurality of the information processing apparatuses 20 is grouped as one group by associating with the same URL of the upload-use page 33 uploadable with the document/image data 52, the identification unit 156 of the control apparatus 10 compares the operation time range set for each of the information processing apparatus 20, which is stored in the management information 53, and the current time to identify at least one information processing apparatus 20 set with the operation time range corresponding to the current time as the transmission destination of the document/image data 52. The operation time range included in the management information 53 is not limited to information of the time range, but can be information of each day of the week, or time point.

### Identification of Information Processing Apparatus:

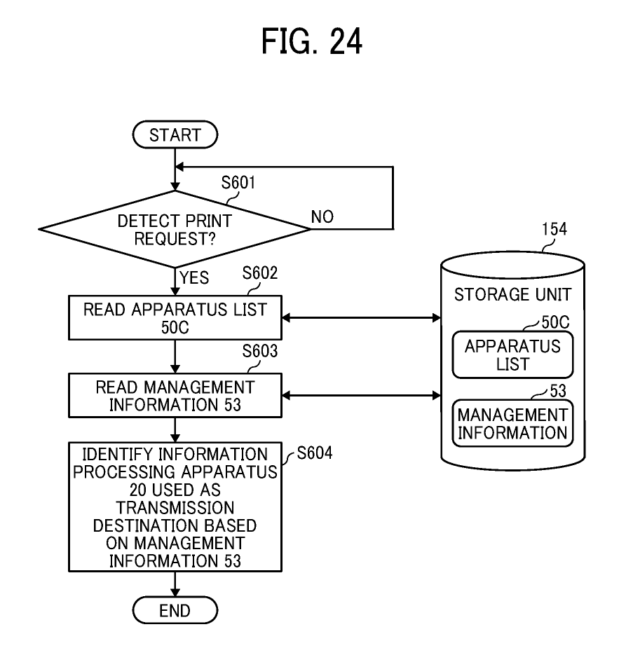

Hereinafter, a description is given of identification of the information processing apparatus 20 in the information processing control system 1d of the second embodiment with reference to FIG. 24. FIG. 24 illustrates an example of a flowchart illustrating the steps of processing of the control apparatus 10 of the second embodiment.

In step S601, the identification unit 156 of the control apparatus 10d determines whether the identification unit 156 detects a print request of the document/image data 52. If the identification unit 156 of the control apparatus 10d detects the print request of the document/image data 52 (S601: YES), the control apparatus 10d proceeds the sequence to step S602. On the other hand, if the identification unit 156 of the control apparatus 10d does not detect the print request of the document/image data 52 (S601: NO), the identification unit 156 repeats step 601 until the identification unit 156 detects the print request of the document/image data 52. Before detecting the print request in step S601, steps S401 to S413 illustrated in FIG. 14 are performed.

In step S602, the identification unit 156 of the control apparatus 10d reads the apparatus list 50C stored in the storage unit 154. Then, the identification unit 156 of the control apparatus 10d extracts a group of the information processing apparatuses 20 associated with the same URL of the upload-use page 33 uploadable with the document/image data 52 from the read apparatus list 50C.

In step S603, the identification unit 156 of the control apparatus 10d reads the management information 53 stored in the storage unit 154.

In step S604, the identification unit 156 of the control apparatus 10d identifies the information processing apparatus 20 to be used as the transmission destination of the document/image data 52 based on the management information 53. Specifically, if the plurality of information processing apparatuses 20 is grouped as one group by associating with the same URL of the upload-use page 33 uploadable with the document/image data 52, the identification unit 156 of the control apparatus 10 compares the operation time range set for each of the information processing apparatus 20, stored in the management information 53, and the current time to identify at least one information processing apparatus 20 set with the operation time range corresponding to the current time as the transmission destination of the document/image data 52.

As to the above described second embodiment, the control apparatus 10d identifies the information processing apparatus 20 to be used as the transmission destination of the document/image data 52 uploadable from the user terminal 35 based on the information of the operation time range set for each of the information processing apparatuses 20, stored in the management information 53. With this configuration, even if two or more information processing apparatuses 20 are associated with the same URL of the one upload-use page 33, the document/image data 52 can be transmitted from the user terminal 35 to the specific information processing apparatus 20.

### Variant Example of Second Embodiment

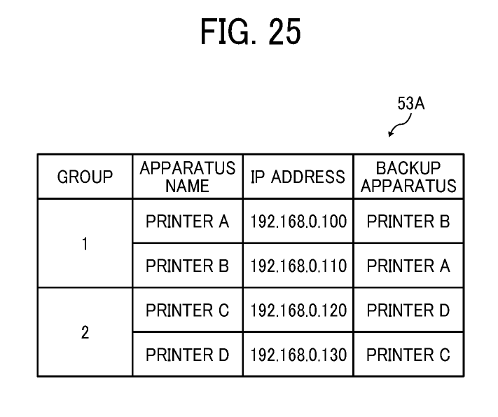

Hereinafter, a description is given of a variant example of the second embodiment with reference to FIG. 25. In an information processing control system 1e of the variant example of the second embodiment, when one information processing apparatus 20 is identified as the transmission destination of the document/image data 52 by the control apparatus 10, but the identified one information processing apparatus 20 cannot be used due to some reasons, the document/image data 52 can be transmitted to another information processing apparatus 20.

FIG. 25 illustrates an example of management information 53A of the variant example of the second embodiment. As illustrated in FIG. 25, the management information 53A includes information of a backup apparatus set for each of the information processing apparatuses 20 instead of the operation time range included in the management information 53 illustrated in FIG. 23. The backup apparatus can be used as an alternative information processing apparatus when one information processing apparatus 20 identified as the transmission destination of the document/image data 52 by the control apparatus 10 cannot be used due to some reasons.

For example, printer B is set as a backup apparatus of printer A, and printer A is set as a backup apparatus of printer B in the management information 53A. Further, for example, printer D is set as a backup apparatus of printer C, and printer C is set as a backup apparatus of printer D in the management information 53A. The management information 53A is an example of operation conditions uniquely settable for each of the information processing apparatuses 20, in which the operation conditions set differently.

The management information 53A can be changed and set by the control apparatus 10 or the administrator terminal 30 as needed. The backup apparatus included in the management information 53A is preferably one or more information processing apparatuses 20 disposed in the same group illustrated in FIG. 23. If the information processing apparatuses 20 in the same group are set as the backup apparatuses with each other, even if a user cannot use one information processing apparatus 20, the user can use another information processing apparatus 20 disposed on the same floor to print the document/image data 52 without waiting the problem solving of the one information processing apparatus 20.

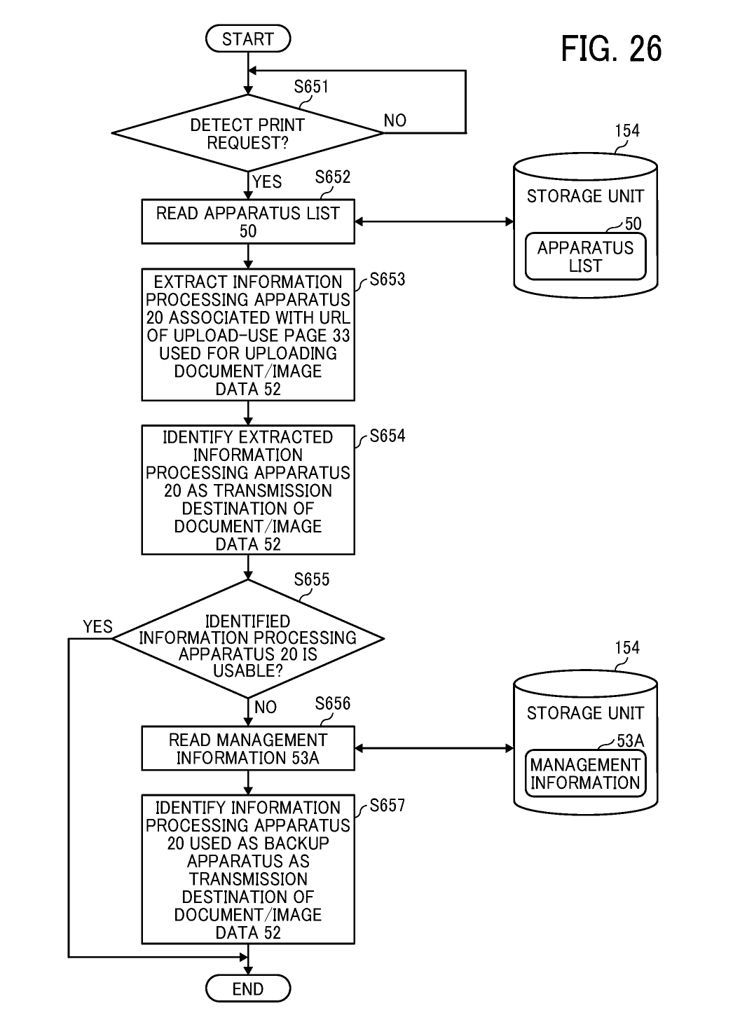

FIG. 26 illustrates an example of a flowchart illustrating the steps of processing of the control apparatus 10d of the second embodiment. Since steps S651 to S654 in FIG. 26 are same as steps S501 to S504 illustrated in FIG. 16, the description thereof will be omitted.

In step S655, the identification unit 156 of the control apparatus 10d determines whether the identified information processing apparatus 20 is usable. If the identified information processing apparatus 20 is not usable (S655: NO), the identification unit 156 of the control apparatus 10d proceeds the sequence to step S656. On the other hand, if the identified information processing apparatus 20 is usable (S655: YES), the identification unit 156 of the control apparatus 10d ends the sequence, and transmits the document/image data 52 to the identified information processing apparatus 20.

In step S656, the identification unit 156 of the control apparatus 10 reads the management information 53A stored in the storage unit 154.

In step S657, the identification unit 156 of the control apparatus 10 identifies the information processing apparatus 20, included in the read management information 53A as the backup apparatus of the information processing apparatus 20 identified in step S654, as the transmission destination of the document/image data 52a.

With this configuration, in the information processing control system 1e of the variant example of the second embodiment, even if one information processing apparatus 20 identified as the transmission destination of the document/image data 52 by the control apparatus 10d cannot be used due to some reasons, the document/image data 52 can be transmitted to another information processing apparatus 20, which is the backup apparatus of the identified information processing apparatus 20, so that the document/image data 52 transmitted from the user terminal 35 can be printed using the backup apparatus.

### Third Embodiment

Hereinafter, a description is given of an information processing control system 1f of a third embodiment. In the information processing control system 1f of the third embodiment, the control apparatus 10f performs data processing of the document/image data 52 uploaded to the upload-use page 33. The same configurations and same functions as those of the first embodiment are denoted by the same reference numerals, and the description thereof will be omitted.

### Functional Configuration:

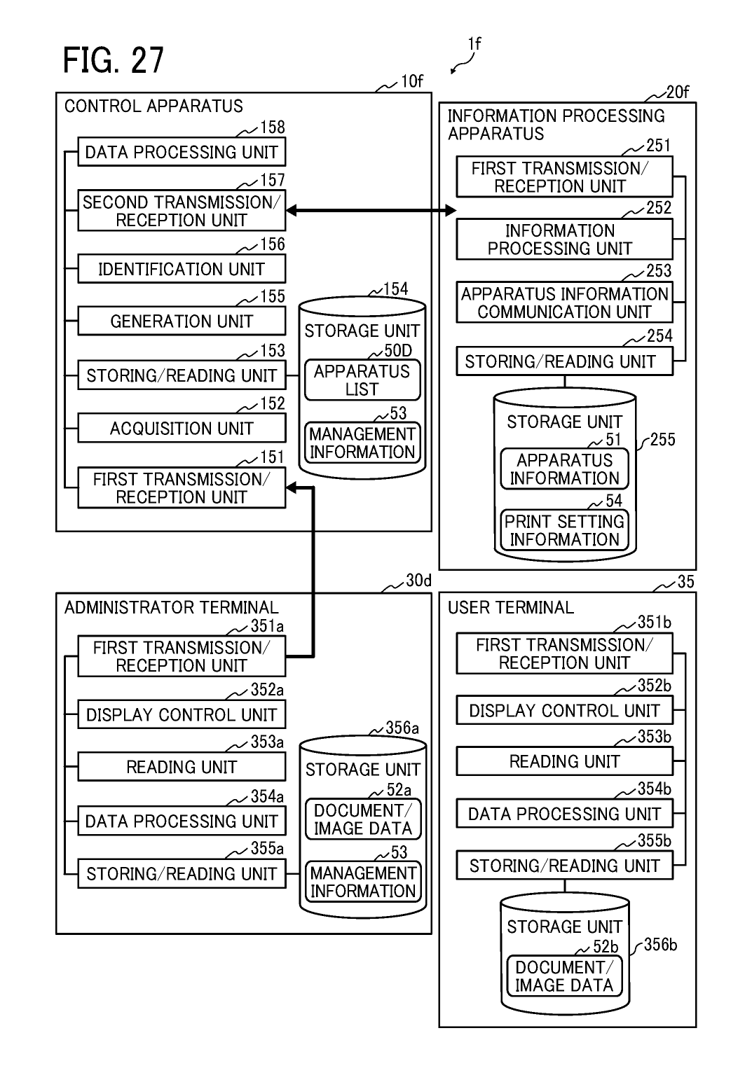

FIG. 27 illustrates an example of a functional block diagram of the information processing control system 1f of the third embodiment. As illustrated in FIG. 27, the control apparatus 10f includes a data processing unit 158 in addition to the functions of the first embodiment. The control apparatus 10f further stores apparatus list 50D in the storage unit 154. Further, as illustrated in FIG. 27, the information processing apparatus 20f stores print setting information 54 in the storage unit 255 in addition to the information of the first embodiment.

The data processing unit 158 performs data processing of data uploaded to the upload-use page 33. The data processing unit 158 performs a setting process for printing the document/image data 52 (e.g., print target data) uploaded to the upload-use page 33 based on the print setting information 54 included in the apparatus list 50D stored in the storage unit 255. The data processing unit 158 is an example of the data processing unit.

The print setting information 54 stored in the storage unit 255 of the information processing apparatus 20f includes information of the pre-set print settings of the information processing apparatus 20f. A detail of the print setting information 54 will be described later. The apparatus list 50D stored in the storage unit 154 of the control apparatus 10f includes the print setting information 54 in addition to the information included in the apparatus list 50 illustrated in FIG. 8.

The print setting information 54 is acquired from each of the information processing apparatuses 20f. In the third embodiment, the control apparatus 10f acquires the print setting information 54 from the information processing apparatus 20f, but not limited thereto. For example, the control apparatus 10f can acquire the print setting information 54 from the administrator terminal 30f when an administrator of the information processing control system 1f inputs the print setting information 54 using the administrator terminal 30f.

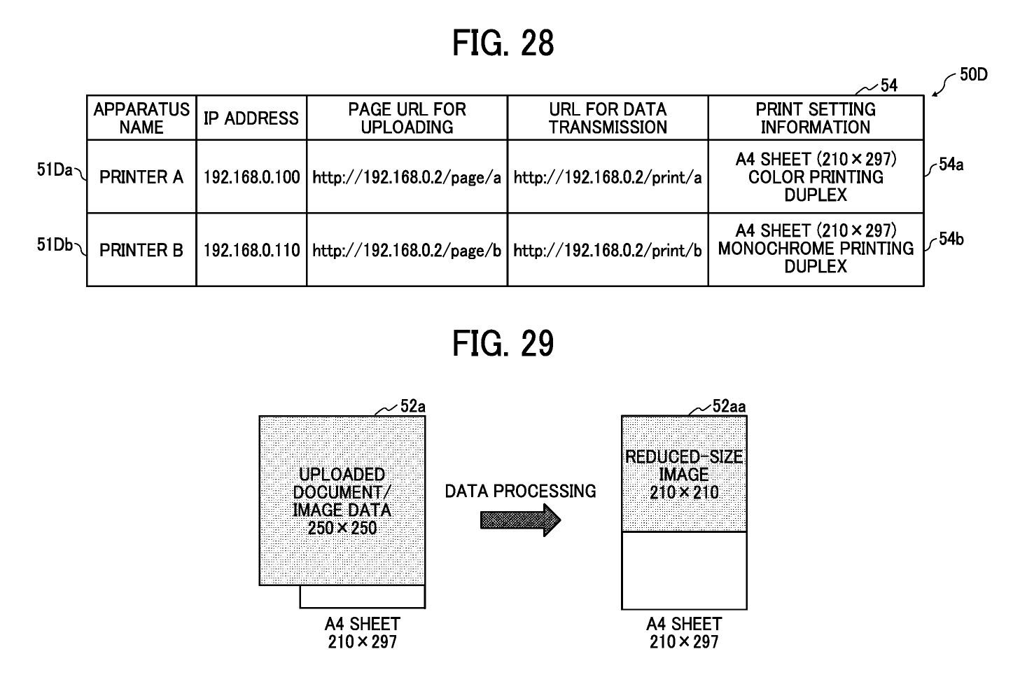

Further, the control apparatus 10f can be configured to determine the print setting information 54 using a function (capability) of the information processing apparatus 20 acquired by using SNMP or the like. For example, the information processing apparatus 20 corresponding to color printing is automatically set with the pre-set print settings of color printing, and the information processing apparatus 20 not corresponding to color printing is automatically set with the pre-set print settings of black-and-white printing. Hereinafter, a description is given of a detail of the print setting information 54 with reference to FIG. 28. FIG. 28 illustrates an example of an apparatus list 50D in the third embodiment. FIG. 28 illustrates the apparatus list 50D stored in the storage unit 154. As illustrated in FIG. 28, the apparatus list 50D includes information listing the apparatus information 51 and the print setting information 54 of the information processing apparatus 20. The apparatus list 50D includes the print setting information 54 in addition to the information included in the apparatus list 50 illustrated in FIG. 8.

The print setting information 54 is information of the pre-set print settings set for the information processing apparatus 20. The print setting information 54 includes, for example, information related to printing using the information processing apparatus 20, such as information of a sheet size used for printing, information of either black and white printing or color printing, information of one sided printing or double-sided printing (i.e., duplex printing), or the like.

In FIG. 28, for example, the print setting information 54a included in apparatus information 51Da of the information processing apparatus 20a is set with A4 sheet (210 mm×297 mm) as the information of the sheet size used for printing by the information processing apparatus 20a. Further, the print setting information 54a is set with the color printing and duplex printing as the pre-set print settings.

Similarly, for example, the print setting information 54b included in apparatus information 51Db of the information processing apparatus 20b is set with A4 sheet (210 mm×297 mm) as the information of the sheet size used for printing by the information processing apparatus 20b. Further, the print setting information 54b is set with the color printing and duplex printing as the pre-set print settings.

Hereinafter, a description is given of data processing based on the print setting information 54 with reference to FIG. 29. FIG. 29 illustrates a scheme of processing of the data processing unit 158 of the control apparatus 10f of the third embodiment. FIG. 29 illustrates the uploaded document/image data 52a, and document/image data 52aa processed by the data processing unit 158. The print setting information 54a includes the information of sheet size used for printing as one of the preset print settings set for the information processing apparatus 20a.

In an example case of FIG. 29, it is assumed that the print setting information 54a is set with A4 size (210 mm×297 mm) as the sheet size used for printing. In FIG. 29, the uploaded document/image data 52a has a size of “250 mm×250 mm” that is larger than “210 mm×297 mm” of A4 size sheet set for the print setting information 54a. In this case, if the document/image data 52a having the data size larger than the sheet size of the preset print settings of the information processing apparatus 20a is printed, some of the print target data cannot be printed on the sheet.

Therefore, the data processing unit 158 of the control apparatus 10f acquires the data size of the uploaded document/image data 52a, and compares the data size of the uploaded document/image data 52a and the sheet size set for the print setting information 54a. Then, if the data size of the document/image data 52a is larger than the sheet size set for the print setting information 54a, the data processing unit 158 of the control apparatus 10 performs reduction of the data size of the document/image data 52a.

If a length of a short side of the document/image data 52a exceeds 210 mm and/or a length of a long side of the document/image data 52a exceeds 297 mm, the data processing unit 158 of the control apparatus 10 performs the reduction of the document/image data 52a based on a ratio of the length of the short side and/or the long side exceeding the sheet size set for the print setting information 54a.

In an example case of FIG. 29, the length of the short side (i.e., 250 mm) of the document/image data 52a exceeds the sheet size (i.e., 210 mm) set for the print setting information 54a, thus the data processing unit 158 of the control apparatus 10 reduces the length of the short side of the document/image data 52a based on the excess ratio of the short side of the document/image data 52a to generate the document/image data 52aa. As above described, the control apparatus 10 performs the reduction of the document/image data 52 uploaded to the upload-use page 33 based on the print setting information 54.

### Printing Process:

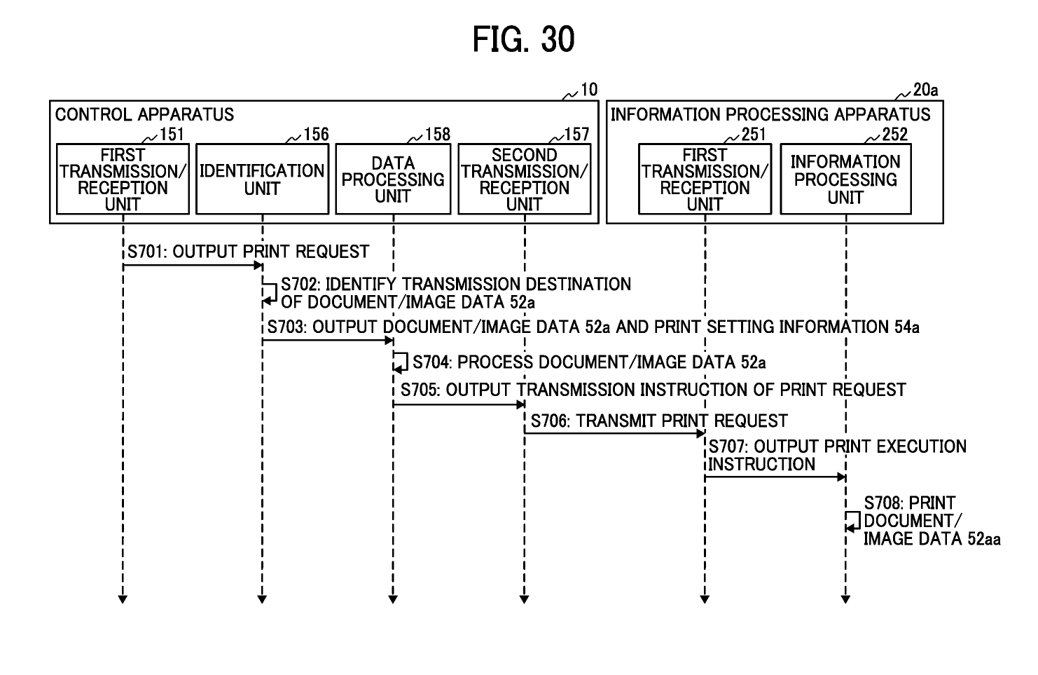

FIG. 30 illustrates an example of a sequence diagram of a printing process in the information processing control system 1f of the third embodiment. FIG. 30 illustrates an example case that the user terminal 35 requests the information processing apparatus 20a to print the target data. FIG. 30 illustrates the sequence to be performed after the document/image data 52a is uploaded to the upload-use page 33a from the user terminal 35. The document/image data 52a is uploaded to the upload-use page 33a using the sequence of steps S401 to S411 illustrated in FIG. 14.

In step S701, the first transmission/reception unit 151 of the control apparatus 10f outputs a print request of the uploaded document/image data 52a to the identification unit 156.

In step S702, after the identification unit 156 of the control apparatus 10f detects the print request of the document/image data 52a, the identification unit 156 identifies the information processing apparatus 20 to be used as the transmission destination of the document/image data 52a.

The identification processing of the information processing apparatus 20 by the identification unit 156 is performed using any one of the sequences described in the first and second embodiments. In an example case of FIG. 30, since the document/image data 52a is uploaded to the upload-use page 33a, the identification unit 156 selects the information processing apparatus 20a as the transmission destination of the document/image data 52a.

In step S703, after the identification unit 156 of the control apparatus 10f identifies the information processing apparatus 20a as the transmission destination of the document/image data 52a, the identification unit 156 outputs the document/image data 52a and the print setting information 54a to the data processing unit 158.

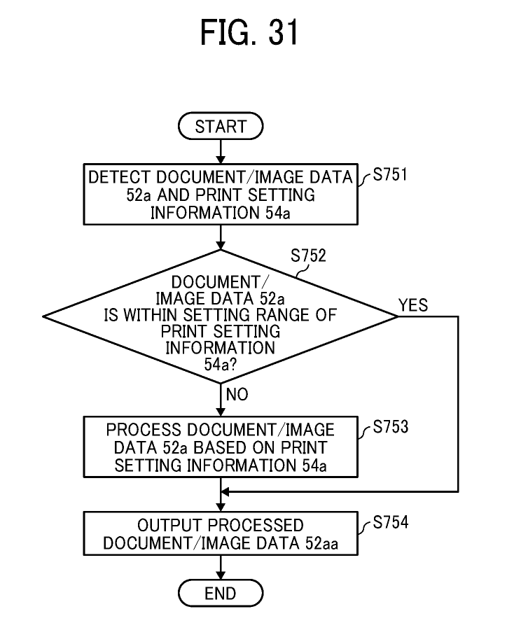

In step S704, the data processing unit 158 of the control apparatus 10f performs the data processing of the document/image data 52a based on the print setting information 54a. Hereinafter, a description is given of a detail of the processing of the data processing unit 158 with reference to FIG. 31. FIG. 31 illustrates an example of a flowchart illustrating the steps of processing in the data processing unit 158 of the control apparatus 10 of the third embodiment.

In step S751, the data processing unit 158 of the control apparatus 10 detects the document/image data 52a and the print setting information 54a.

In step S752, the data processing unit 158 determines whether the document/image data 52a is within a setting range of the print setting information 54a. If the document/image data 52a is within the setting range of the print setting information 54a (S752: YES), the data processing unit 158 of the control apparatus 10 proceeds the sequence to step 754. Specifically, the data processing unit 158 acquires the size of the document/image data 52a, and compares the size of the document/image data 52a and the sheet size set for the print setting information 54a. If the size of the document/image data 52a is smaller than the sheet size set for the print setting information 54a, the data processing unit 158 determines that the document/image data 52a is within the setting range of the print setting information 54a (S752: YES).

On the other hand, if the size of the document/image data 52a is not within the setting range of the print setting information 54a (S752: NO), the data processing unit 158 of the control apparatus 10 proceeds the sequence to step S753. Specifically, when the size of the document/image data 52a is larger than the sheet size set for the print setting information 54a, the data processing unit 158 determines that the document/image data 52a is not within the setting range of the print setting information 54a (S752: NO).

If the size of the document/image data 52a is not within the setting range of the print setting information 54 (S752: NO), in step S753, the data processing unit 158 of the control apparatus 10 performs the data processing of the document/image data 52a based on the print setting information 54a. Specifically, if the size of the document/image data 52a of the print setting information 54 is larger than the sheet size set for the print setting information 54a (S752: NO), the data processing unit 158 of the control apparatus 10 performs the size reduction of the document/image data 52a.

In step S754, the data processing unit 158 of the control apparatus 10 outputs document/image data 52aa, generated by performing the size reduction of the document/image data 52a in step S753. Further, instead of outputting the document/image data 52aa generated by performing the size reduction to the document/image data 52a, the data processing unit 158 can be configured to output information to be used for reducing the size of the document/image data 52a. On the other hand, if the data processing unit 158 determines that the document/image data 52a is within the setting range of the print setting information 54a (S752: YES), the data processing unit 158 outputs the document/image data 52a in step S754.

Referring to FIG. 30 again, the description of the printing process in the information processing control system 1f is continued.

In step S705, the data processing unit 158 of the control apparatus 10 outputs a transmission instruction of the print request of the document/image data 52aa, generated by performing the size reduction processing, to the second transmission/reception unit 157.

In step S706, after the second transmission/reception unit 157 of the control apparatus 10 detects the transmission instruction of the print request of the document/image data 52aa output from the second transmission/reception unit 157, the second transmission/reception unit 157 transmits the print request of the document/image data 52aa to the information processing apparatus 20a. Specifically, the second transmission/reception unit 157 of the control apparatus 10f, operated as the HTTP server, transmits the print request of the document/image data 52aa to the IP address “192.168.0.100” set for the information processing apparatus 20a (see FIG. 8). Then, the first transmission/reception unit 251 of the information processing apparatus 20a receives the print request of the document/image data 52aa using a protocol such as FTP, HTTP, HTTPS, or LPD.

In step S707, after the first transmission/reception unit 251 of the information processing apparatus 20a receives the print request of the document/image data 52aa, the first transmission/reception unit 251 outputs a print execution instruction of the document/image data 52aa to the information processing unit 252.

In step S708, after the information processing unit 252 of the information processing apparatus 20a detects the print execution instruction of the document/image data 52aa output from the first transmission/reception unit 251, the information processing unit 252 performs printing of the document/image data 52aa. With this configuration, the document/image data 52aa, generated by performing the size reduction processing using the control apparatus 10f, is printed by the information processing apparatus 20a.

As to the above described the information processing control system 1f of the third embodiment, the control apparatus 10f performs the data processing of the document/image data 52 uploaded from the user terminal 35 based on the print setting information 54 of the information processing apparatus 20f (e.g., information processing apparatus 20a in FIG. 30). Therefore, even if the size of the document/image data 52 uploaded by the user terminal 35 is larger than the sheet size set for the print setting information 54 of the information processing apparatus 20a, the control apparatus 10f can perform the printing of the document/image data 52 after performing the size reduction of the target data based on the print setting information 54.

### Fourth Embodiment

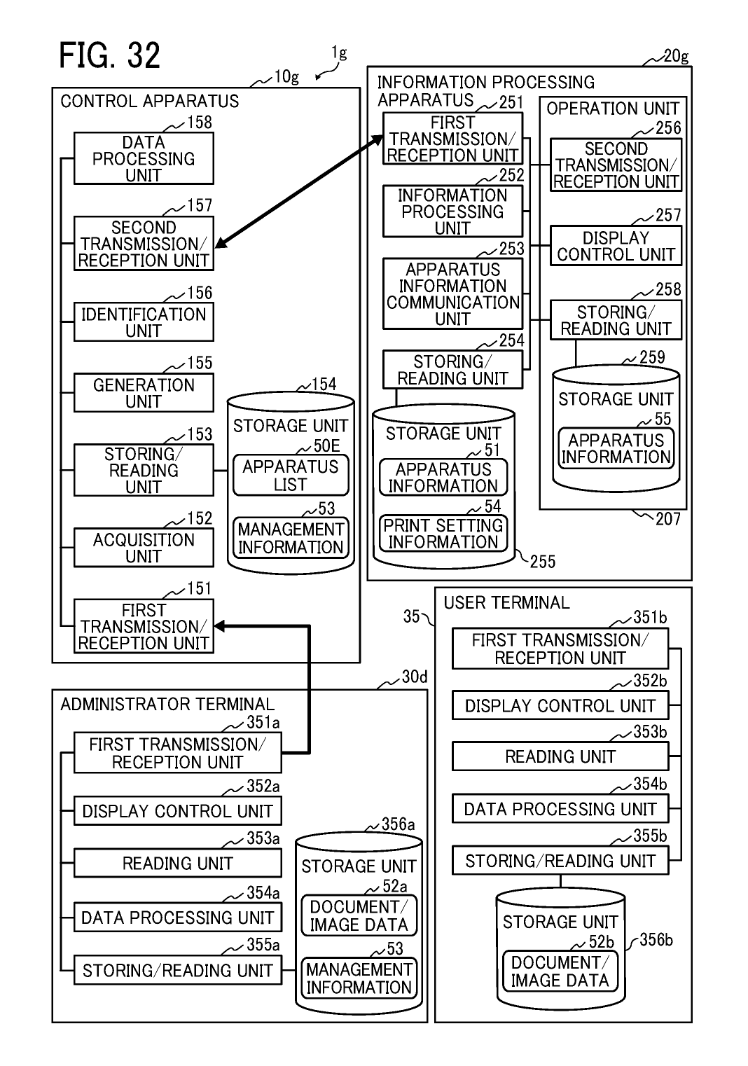

Hereinafter, a description is given of a fourth embodiment with reference to FIG. 32. In the fourth embodiment, an information processing apparatus 20g includes an operation panel in addition to a main unit having a printer function. As to an information processing control system 1g of the fourth embodiment, not only the connection information 21 such as the two-dimensional code is printed, but also the connection information 21 is displayed on the operation panel of the information processing apparatus 20g, with which the information processing apparatus 20g can be more reliably associated with the connection information 21. The same configurations and functions as those of the first to the third embodiments are denoted by the same or similar reference numerals, and the description thereof will be omitted.

### Functional Configuration:

FIG. 32 illustrates an example of a functional block diagram of the information processing control system 1g of the fourth embodiment. As illustrated in FIG. 32, the information processing apparatus 20g includes the operation unit 207, which corresponds to the operation unit 207 of FIG. 5, including a second transmission/reception unit 256, a display control unit 257, a storing/reading unit 258, and a storage unit 259 in addition to the functions of the first to third embodiments. The operation unit 207 is implemented, for example, by an operation panel capable of inputting information by a user and displaying information. Further, the operation unit 207 is implemented by an operation panel having a touch panel function and a drawing function.

The second transmission/reception unit 256 has a function of transmitting and receiving data between the operation unit 207 and the control apparatus 10g. The second transmission/reception unit 256 serves as a browser function. The second transmission/reception unit 256 receives, for example, the document/image data 52 (i.e., display target data) transmitted from the control apparatus 10g. The second transmission/reception unit 256 is implemented by, for example, executing programs using the operation unit 207 and CPU 201 illustrated in FIG. 5.

The display control unit 257 displays the connection information 21 received by the second transmission/reception unit 256 using the operation unit 207. The display control unit 257 is implemented by, for example, the operation unit 207 and executing programs using the CPU 201 illustrated in FIG. 5.

The storing/reading unit 258 stores various data in the storage unit 259, and reads various data from the storage unit 259. The storing/reading unit 258 and the storage unit 259 are implemented by, for example, the operation unit 207, the ROM 102, the storage 104, and executing programs using the CPU 101 illustrated in FIG. 5. The storage unit 255 stores apparatus information 55 in the fourth embodiment.

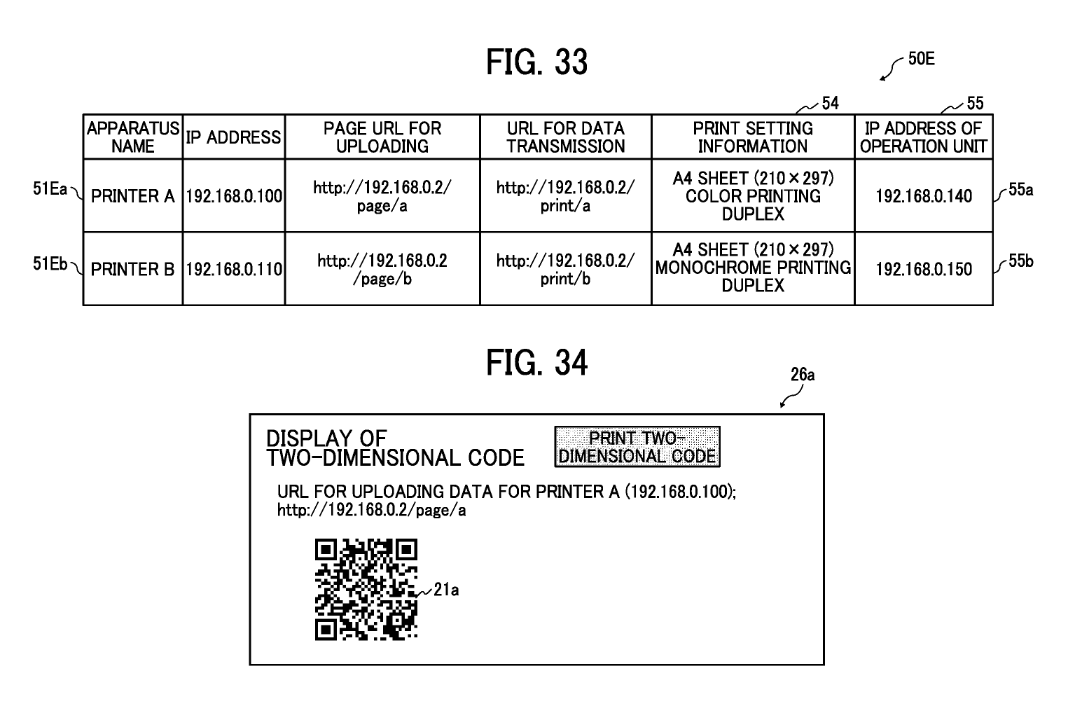

Hereinafter, a description is given of a detail of the apparatus information 55 with reference to FIG. 33. FIG. 33 illustrates an example of an apparatus list 55E of the fourth embodiment. FIG. 33 illustrates the apparatus list 50E stored in the storage unit 154. As illustrated in FIG. 33, the apparatus list 50E includes information listing the apparatus information 51, the print setting information 54, and the apparatus information 55 of each of the information processing apparatuses 20. The apparatus list 50E includes the apparatus information 55 in addition to the information included in the apparatus list 50D illustrated in FIG. 28. The apparatus information 55 is information of an IP address of the operation unit 207.

In FIG. 33, apparatus information 55a included in apparatus information 51Ea of the information processing apparatus 20a is the IP address “192.168.0.140” set for the operation unit 207 of the information processing apparatus 20a. Further, apparatus information 55b included in apparatus information 51Eb of the information processing apparatus 20b is the IP address “192.168.0.150” set for the operation unit 207 of the information processing apparatus 20b.

FIG. 34 illustrates an example of a display image 36a displayed using the operation unit 207 of the fourth embodiment. The display image 26a illustrated in FIG. 34 is displayed using the operation unit 207 of the information processing apparatus 20a. As illustrated in FIG. 34, the display image 26a includes, for example, the connection information 21a associated with the information processing apparatus 20a. Further, the display image 26a displays a message of the upload URL of “http://192.168.0.2/page/a” set for the information processing apparatus 20a embedded in the two-dimensional code as the connection information 21a. Further, the display image 26a includes the IP address “192.168.0.100” set for the information processing apparatus 20a. Further, the display image 26a can also display similar information for the information processing apparatus 20b.

The display image 26a includes, for example, an icon of “print two-dimensional code” to request printing of the connection information 21a (i.e., two-dimensional code). The information processing apparatus 20a performs printing of the connection information 21a when a user selects the icon of “print two-dimensional code.” The display image 26a of the connection information 21a illustrated in FIG. 34 is just one example, and not limited thereto. Further, the operation unit 207 of the information processing apparatus 20b also displays the connection information 21b associated with the information processing apparatus 20b.

### Display Processing of Connection Information:

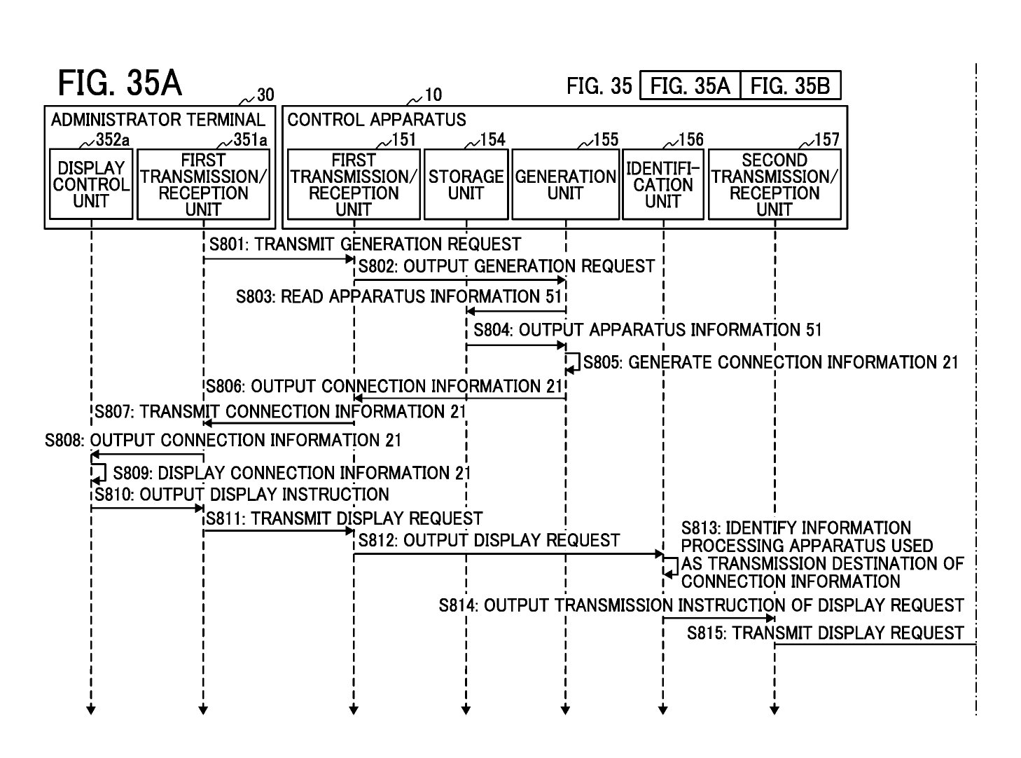

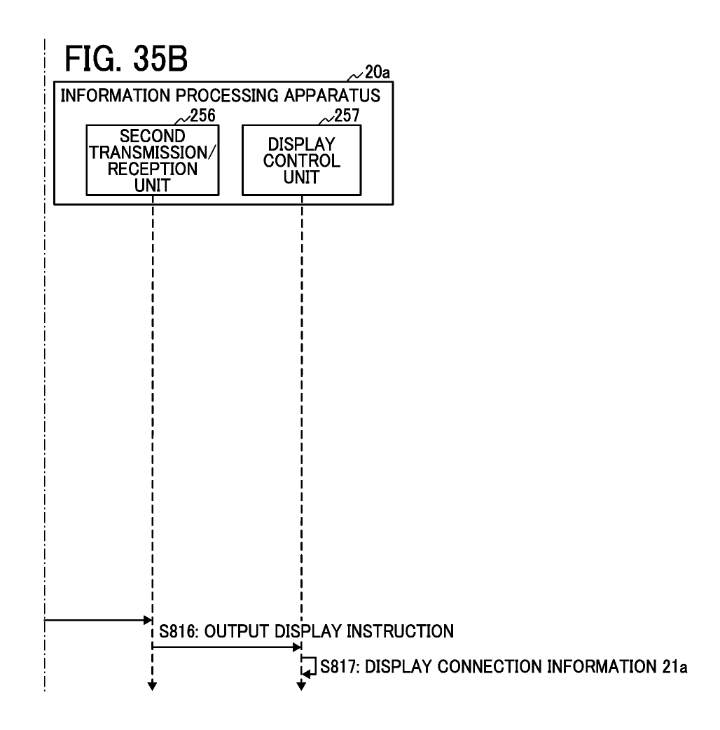

FIG. 35 (35A, 35B) illustrates an example of a sequence diagram of display processing of the connection information in the information processing control system 1g of the fourth embodiment. Since steps S801 to S809 are same as steps S202 to S209 in FIG. 10, the description of steps S801 to S809 will be omitted.

In step S810, the display control unit 352a of the administrator terminal 30 outputs a display instruction of the connection information 21 to the first transmission/reception unit 351a.

In step S811, after the first transmission/reception unit 351a of the administrator terminal 30 detects the display instruction of the connection information 21 output from the display control unit 352a, the first transmission/reception unit 351a transmits a display request of the connection information 21 to the control apparatus 10. Specifically, for example, the first transmission/reception unit 351a of the administrator terminal 30 transmits the display request of the connection information 21 to the control apparatus 10 using an HTTP request (e.g., POST http://192.168.0.2/2d_code/display).

In step S812, after the first transmission/reception unit 151 of the control apparatus 10 receives the display request of the connection information 21, the first transmission/reception unit 151 outputs the display request of the connection information 21 to the identification unit 156.

In step S813, after the identification unit 156 of the control apparatus 10 detects the display request of the connection information 21 output from the first transmission/reception unit 151, the identification unit 156 identifies the information processing apparatus 20 to be transmitted with the display request of the connection information 21. Specifically, the identification unit 156 identifies the operation unit 207 of the information processing apparatus 20 associated with the URL of the upload-use page 33 included in the connection information 21 as the transmission destination of the display request of the connection information 21.

In an example case of FIG. 35, it is assumed that the connection information 21 includes the URL of the upload-use page 33a set for the information processing apparatus 20a, and the identification unit 156 identifies the operation unit 207 of the information processing apparatus 20a as the transmission destination of the display request of the connection information 21.

In step S814, after the identification unit 156 of the control apparatus 10 identifies the operation unit 207 of the information processing apparatus 20a as the transmission destination of the display request of the connection information 21, the identification unit 156 outputs a transmission instruction of the display request of the connection information 21 to the second transmission/reception unit 157.

In step S815, after the second transmission/reception unit 157 of the control apparatus 10 detects the transmission instruction of the display request of the connection information 21a output from the identification unit 156, the second transmission/reception unit 157 transmits the display request of the connection information 21a to the information processing apparatus 20a. Specifically, the first transmission/reception unit 151 of the control apparatus 10, operated as the HTTP server, transmits the display request of the connection information 21a to the IP address of “192.168.0.140” set for the operation unit 207 of the information processing apparatus 20a associated with the connection information 21a. Further, in step 815, the second transmission/reception unit 157 of the control apparatus 10 can also transmit the print request of the connection information 21a to the information processing apparatus 20a.

In step S816, after the second transmission/reception unit 256 receives the display request of the connection information 21a, the second transmission/reception unit 256 outputs a display instruction of the connection information 21a to the display control unit 257.

In step S817, after the display control unit 257 of the information processing apparatus 20a detects the display instruction of the connection information 21a, the display control unit 257 displays the connection information 21a using the operation unit 207. With this configuration, the operation unit 207 of the information processing apparatus 20a displays the connection information 21a associated with the information processing apparatus 20a.

FIG. 35 illustrates an example case of displaying the connection information 21a on the operation unit 207 of the information processing apparatus 20a, and further, the connection information 21b of the information processing apparatus 20b can be also displayed on the operation unit 207 of the information processing apparatus 20b.

As to the above described information processing control system 1g of the fourth embodiment, not only the connection information 21 such as the two-dimensional code is printed, but also the connection information 21 is displayed using the operation unit 207 of the information processing apparatus 20. Therefore, in the information processing control system 1g, the information processing apparatus 20 is more reliably associated with the connection information 21. Further, in the information processing control system 1g, the connection information 21 can be displayed using the operation unit 207, with which a work load of an administrator such as printing the connection information 21 can be omitted.

### Variant Example of Fourth Embodiment

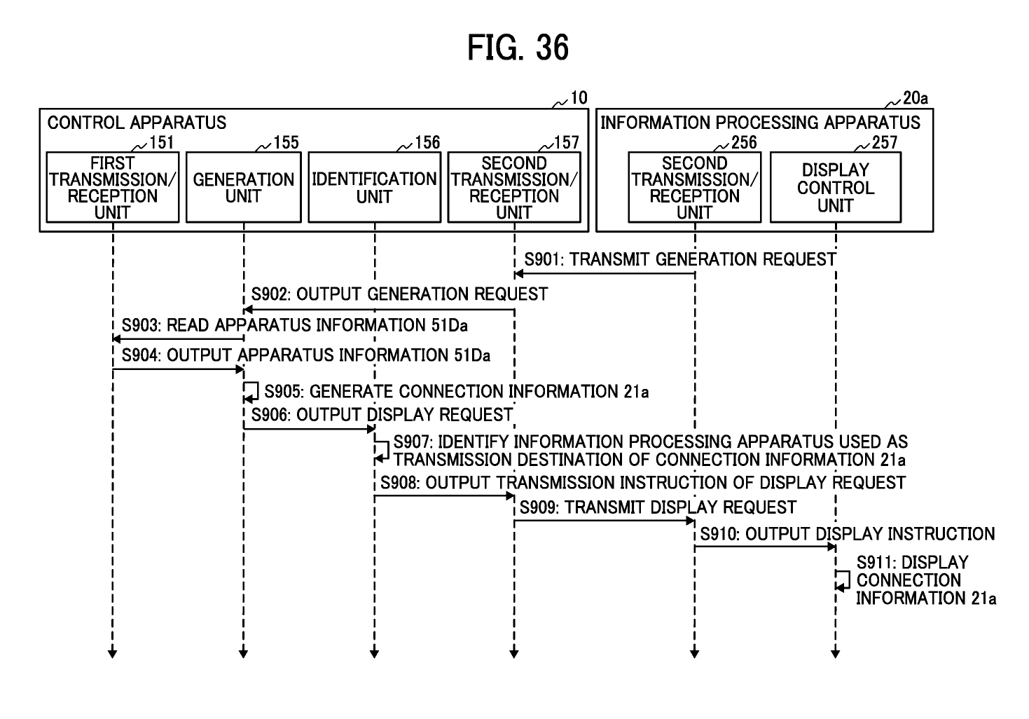

Hereinafter, a description is given of a variant example of the fourth embodiment with reference to FIG. 36. In an information processing control system 1h of the variant example of the fourth embodiment, the operation unit 207 disposed for the information processing apparatus 20 transmits a request for generating the connection information 21a to the control apparatus 10.

FIG. 36 illustrates an example of a sequence diagram of processing for generating the connection information in the information processing control system 1h of the variant example of the fourth embodiment.

In step S901, the second transmission/reception unit 256 of the information processing apparatus 20a transmits a request for generating the connection information 21a to the control apparatus 10. Specifically, the second transmission/reception unit 256 of the information processing apparatus 20a, serving as a browser, transmits the request for generating the connection information 21a associated with the information processing apparatus 20a to the control apparatus 10. Then, the second transmission/reception unit 157 of the control apparatus 10, operated as the HTTP server, receives the request for generating the connection information 21a transmitted from the information processing apparatus 20a.

In step S902, the second transmission/reception unit 157 of the control apparatus 10 outputs the request for generating the received connection information 21a to the generation unit 155.

In step S903, after the generation unit 155 of the control apparatus 10 detects the request for generating the connection information 21a output from the second transmission/reception unit 157, the generation unit 155 reads the apparatus information 51Da (FIG. 28) from the storage unit 154. Specifically, the generation unit 155 outputs a reading request for reading the apparatus information 51Da to the storing/reading unit 153. After the storing/reading unit 153 detects the reading request, the storing/reading unit 153 reads the apparatus information 51Da stored in the storage unit 154.

In step S904, the storage unit 154 of the control apparatus 10 outputs the apparatus information 51Da to the generation unit 155. Specifically, the storage unit 154 outputs the apparatus information 51Da to the storing/reading unit 153. Then, the storing/reading unit 153 outputs the apparatus information 51Da to the generation unit 155.

In step S905, after the generation unit 155 of the control apparatus 10 detects the apparatus information 51Da, the generation unit 155 generates the connection information 21a. The method of generating the connection information 21a can use the sequence of FIG. 11.

In step S906, after the generation unit 155 generates the connection information 21a, the generation unit 155 of the control apparatus 10 outputs a display request of the connection information 21a to the identification unit 156.

In step S907, after the identification unit 156 of the control apparatus 10 detects the display request of the connection information 21a, the identification unit 156 identifies the information processing apparatus 20 to be transmitted with the display request of the connection information 21a. The identification processing of the information processing apparatus 20 by the identification unit 156 is performed using step S813 of FIG. 35. In an example case of FIG. 36, it is assumed that the connection information 21a includes the URL of the upload-use page 33a set for the information processing apparatus 20a, and the identification unit 156 identifies the operation unit 207 of the information processing apparatus 20a as the transmission destination of the display request of the connection information 21a.

In step S908, after the identification unit 156 of the control apparatus 10 identifies the operation unit 207 of the information processing apparatus 20a as the transmission destination of the display request of the connection information 21a, the identification unit 156 outputs a transmission instruction of the display request of the connection information 21a to the second transmission/reception unit 157.

In step S909, after the second transmission/reception unit 157 of the control apparatus 10 detects the transmission instruction of the display request of the connection information 21a, the second transmission/reception unit 157 transmits the display request of the connection information 21a to the information processing apparatus 20a. Specifically, the second transmission/reception unit 157 of the control apparatus 10, operated as the HTTP server, transmits the display request of the connection information 21a to the IP address “192.168.0.140” set for the operation unit 207 of the information processing apparatus 20a illustrated in FIG. 33. Then, the second transmission/reception unit 256 of the information processing apparatus 20a receives the display request of the connection information 21a using a protocol such as FTP, HTTP, HTTPS, or LPD.

In step S910, after the second transmission/reception unit 256 of the information processing apparatus 20a receives the display request of the connection information 21a, the second transmission/reception unit 256 outputs a display instruction of the connection information 21a to the display control unit 257.

In step S911, after the display control unit 257 of the information processing apparatus 20a detects the display instruction of the connection information 21a output from the second transmission/reception unit 256, the display control unit 257 performs display processing of the connection information 21a. With this configuration, the operation unit 207 of the information processing apparatus 20a displays the connection information 21a that is generated based on the generation request transmitted in S901.

FIG. 36 illustrates the configuration that the connection information 21a is displayed using the operation unit 207 of the information processing apparatus 20a, but the connection information 21a can be also printed using the information processing unit 252 of the information processing apparatus 20a. FIG. 36 illustrates an example case that the operation unit 207 of the information processing apparatus 20a transmits the request for generating the connection information 21a, and similarly, the operation unit 207 of the information processing apparatus 20b can transmit a request for generating the connection information 21b.

### Fifth Embodiment

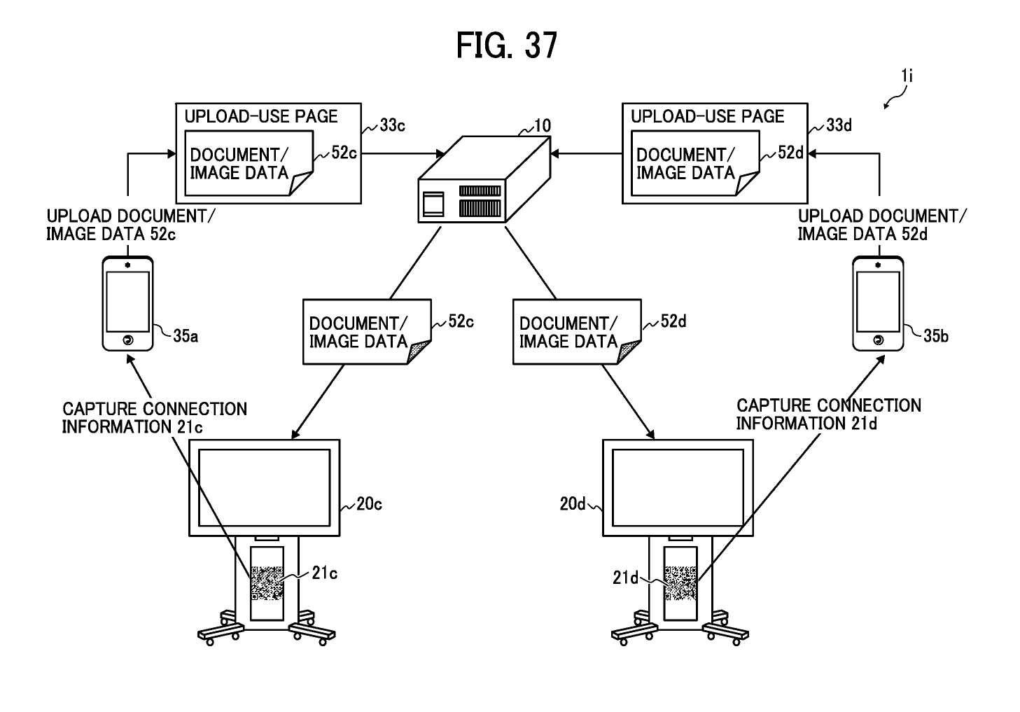

Hereinafter, a description is given of an information processing control system 1i of a fifth embodiment with reference to FIG. 37. In the information processing control system 1i of the fifth embodiment, the configuration of the first to fourth embodiments are applied to parts other than the configuration described below.

FIG. 37 illustrates an example of a system configuration of the information processing control system 1i of the fifth embodiment. In the information processing control system 1i, an apparatus having a display is used as the information processing apparatus 20 that processes the data uploaded to the upload-use page 33 instead of the information processing apparatus 20 having a printing function. Each of the information processing apparatuses 20c and 20d is, for example, an interactive white board (IWB), which has a panel having an electronically writing function, and an interactive communication function.

The user terminal 35a captures and reads connection information 21c associated with the information processing apparatus 20c. The connection information 21c is similar to the connection information 21 illustrated in the first to fourth embodiments. The user terminal 35a uploads document/image data 52c to an upload-use page 33c based on a URL of the upload-use page 33c included in the connection information 21c. The control apparatus 10 transmits the document/image data 52c uploaded to the upload-use page 33c to the information processing apparatus 20c. The processing from the reading of the connection information 21 by the user terminal 35 to the transmitting the uploaded data by the control apparatus 10 is similar to the sequence described in the first to fourth embodiments.

After the information processing apparatus 20c receives the document/image data 52c transmitted from the control apparatus 10, the information processing unit 252 displays the document/image data 52c. With this configuration, as similar to the first to fourth embodiments, in the information processing control system 1i, to-be-displayed data can be easily transmitted from the user terminal 35 to the specific information processing apparatus 20c to be used by a user.

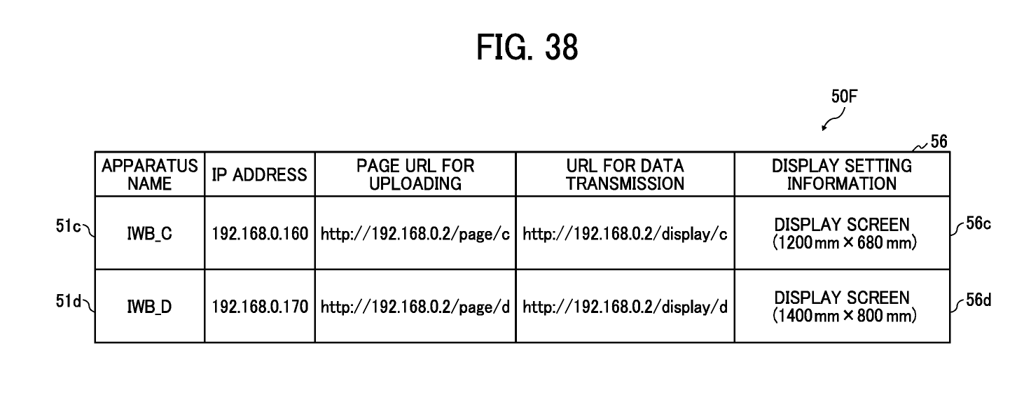

Further, display setting information 56 is stored in the storage unit 255 of the information processing apparatus 20 in the information processing control system 1i, instead of the print setting information 54 used in the third embodiment. Hereinafter, a description is given of a detail of the display setting information 56 with reference to FIG. 38. FIG. 38 illustrates an example of an apparatus list of the fifth embodiment. FIG. 38 illustrates an apparatus list 50F stored in the storage unit 154. As illustrated in FIG. 38, the apparatus list 50F includes information listing the apparatus information 51 and the display setting information 56 of the information processing apparatus 20. The apparatus list 50F includes the display setting information 56 instead of the print setting information 54 included in the apparatus list 50D illustrated in FIG. 28.

The display setting information 56 indicates information of a display screen size of the information processing apparatus 20. In FIG. 38, display setting information 56c included in apparatus information 51c of the information processing apparatus 20c is set with, for example, 1200 mm×680 mm as the display screen size of the information processing apparatus 20c. Similarly, display setting information 56d included in apparatus information 51d of the information processing apparatus 20d is set with, for example, 1400 mm×800 mm as the display screen size of the information processing apparatus 20d.

In the information processing control system 1i, the data processing unit 158 of the control apparatus 10 performs the reduction processing of the document/image data 52c if the uploaded document/image data 52c is not within the setting range of the display setting information 56d as similar to the processing based on the print setting information 54 of the second embodiment.

With this configuration, even if the size of the document/image data 52c uploaded by the user terminal 35 is larger than the size set for the display setting information 56 of the information processing apparatus 20, the control apparatus 10 can perform the data reduction based on the display setting information 56. The information included in the display setting information 56 may include not only information of the display screen size but also other information such as a displayable data size.

As to the above described embodiments, the control apparatus 10 can control data transmission from the external terminal such as the user terminal 35 to the information processing apparatus 20, the control apparatus 10 can identify the information processing apparatus 20 which serves as the transmission destination of the document/image data 52 output from the external terminal based on the given condition uniquely settable for each of the information processing apparatuses 20 (i.e. conditions set for the information processing apparatuses 20 are different), and the control apparatus 10 can transmit the target data to the identified information processing apparatus 20. Therefore, the control apparatus 10 can easily transmit the document/image data 52 output from the external terminal such as the user terminal 35 to the specific information processing apparatus 20.

As to the above described embodiments, the control apparatus 10 includes the output destination information indicating the output destination of the document/image data 52, output from the external terminal such as the user terminal 35, as a given condition, and identifies the information processing apparatus 20 which serves as the transmission destination of document/image data 52 output from the external terminal such as the user terminal 35. Since the output destination of data output from the external terminal such as the user terminal 35 can be set for each of the information processing apparatuses 20 differently, the control apparatus 10 can easily transmit the target data to the information processing apparatus 20 associated with the output destination of data.

Further, as to the above described embodiments, the control apparatus 10 generates the connection information 21 including the output destination information indicating the output destination of the document/image data 52 output from the external terminal such as the user terminal 35, and transmits the generated connection information 21 to the information processing apparatus 20 corresponding to the output destination information. Therefore, the control apparatus 10 can uniquely associate each one of the connection information 21 with each one of the information processing apparatuses 20, in which each one of the connection information 21 is different. Further, the control apparatus 10 can easily transmit the document/image data 52 output from the external terminal such as the user terminal 35, which has read the connection information 21, to the specific information processing apparatus 20 associated with the read connection information 21.

Further, as to the above described embodiments, the control apparatus 10 generates information, to be transmitted and received using the two-dimensional code or the short-range wireless communication, as the connection information 21 including the output destination information indicating the output destination of the document/image data 52 output from the external terminal such as the user terminal 35. Therefore, under the control of the control apparatus 10, the external terminal such as the user terminal 35 can easily acquire the output destination information used for outputting the document/image data 52 when the user terminal 35 is to transmit the document/image data 52 to the specific information processing apparatus 20.

Further, as to the above described embodiments, the control apparatus 10 performs the data processing when printing the document/image data 52 output from the external terminal such as the user terminal 35 based on the print setting information 54 of the information processing apparatus 20. Therefore, even if the size of the document/image data 52 output from the external terminal such as the user terminal 35 is larger than the size set for the print setting information 54 of the information processing apparatus 20, the control apparatus 10 can perform printing of the document/image data 52 after performing the reduction of the document/image data 52 based on the print setting information 54.

Further, as to the above described embodiments, the information processing control system 1 includes the information processing apparatus 20 used for processing data transmitted from an external terminal such as the user terminal 35, the control apparatus 10 used for controlling the transmission of the data from the external terminal to the information processing apparatus 20, and identifying the information processing apparatus 20 as the transmission destination of the data output from the external terminal based on the given condition uniquely settable for each of the information processing apparatuses 20 (i.e., conditions set for the information processing apparatuses 20 are different), and transmitting the target data to the identified information processing apparatus 20. Therefore, the information processing control system 1 can easily transmit the document/image data 52 output from the user terminal 35 to the specific information processing apparatus 20.

Further, as to the above described embodiments, the control apparatus 10 can perform a method of controlling transmission of data from the external terminal, such as the user terminal 35, to the information processing apparatus 20. Specifically, the control apparatus 10 identifies the information processing apparatus 20, to be used as the data transmission destination of the target data, output from the external terminal such as the user terminal 35 based on the given condition uniquely settable for each of the information processing apparatuses 20 (i.e., conditions set for the each of the information processing apparatuses 20 are different), receives the target data output from the external terminal such as the user terminal 35, and transmits the received target data to the identified information processing apparatus 20. With this configuration, the control apparatus 10 can easily transmit the document/image data 52 output from the user terminal 35 to the specific information processing apparatus 20.

Conventionally, if a communication terminal is to use apparatuses connected to a network, the communication terminal needs to identify each apparatus disposed on the network. Therefore, a user needs to input a destination information such as internet protocol (IP) address of each apparatus, which is not convenient for the user. In addition, it is difficult to for the user (e.g., visitor) to select a specific printer appropriately.

One conventional art discloses a method of transmitting document data from a client device to a selected printer using a web browser without requiring an installation of a dedicated driver software.

However, in the above method, if a plurality of information processing apparatuses such as printers exists, a user of the client device (i.e., external terminal) needs to identify a to-be-used specific information processing apparatus. In this case, it is difficult for the user to identify the to-be-used specific information processing apparatus disposed at the front of the user based on apparatus information, in which the user cannot easily transmit the data from the client device (i.e., external terminal) to the to-be-used specific information processing apparatus.

As to the above described embodiments, a user can easily transmit data, output from an external terminal, to a to-be-used specific information processing apparatus.

The functions of each embodiment can be implemented by computer-executable programs written in legacy programming languages such as assembler, C, C++, C #, Java (registered trademark), and the like, and stored and distributed in computer-readable memory such as ROM, electrically erasable and programmable read only memory (EEPROM), erasable programmable read only memory (EPROM), flash memory, flexible disk, compact disk read only memory (CD-ROM), compact disk rewriteable (CD-RW), digital versatile disk read only memory (DVD-ROM), digital versatile disk random access memory (DVD-RAM), digital versatile disk recording only/rewritable (DVD-R/RW), Blu-ray disc, SD card, mini disk (MD), magneto optical disc (MO) and the like, or distributed over a telecommunications line.

Further, a part or all of the functions of each embodiment can be implemented on a programmable device (PD) such as field programmable gate array (FPGA) or the like, or can be implemented as an application specific integrated circuit (ASIC), and can be distributed by a recording medium recording circuit configuration data (bit stream data) downloaded to the PD to implement the functions of the embodiments on the PD, and data described in hardware description language (HDL), very high speed integrated circuits hardware description language (VHDL), Verilog HDL, or the like for generating the circuit configuration data.

Although the description of the present invention has been made based on the embodiments described above for the control apparatus, the information processing control system, the method of controlling data transmission, and the program, the present invention is not limited to the requirements described in the above embodiments. Numerous additional modifications and variations are possible in light of the above teachings. It is therefore to be understood that, within the scope of the appended claims, the disclosure of this patent specification may be practiced otherwise than as specifically described herein.

Each of the functions of the above described embodiments can be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), system on a chip (SOC), graphics processing unit (GPU), and conventional circuit components arranged to perform the recited functions. As described above, the present invention can be implemented in any convenient form, for example using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can compromise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implementable on a programmable device. The computer software can be provided to the programmable device using any storage medium for storing processor readable code such as a floppy disk, hard disk, CD ROM, magnetic tape device or solid state memory device.

What is claimed is:

1. A control apparatus connectable with an external terminal and an information processing apparatus, comprising:
circuitry configured to
identify the information processing apparatus to receive target data, output from the external terminal, based on a condition uniquely set for the information processing apparatus;
receive the target data output from the external terminal; and
transmit the target data, received from the external terminal, to the identified information processing apparatus being a data transmission destination.

2. The control apparatus of claim 1,
wherein the condition includes first destination information indicating a data transfer destination where the target data is output from the external terminal before the target data is transmitted to the information processing apparatus, and
wherein the circuitry identifies the information processing apparatus, associated with the first destination information, as the data transmission destination where the target data is processed.

3. The control apparatus of claim 2, further comprising a memory configured to store the first destination information and second destination information indicating the data transmission destination of the target data by associating the first destination information and the second destination information with each other,
wherein the circuitry identifies the information processing apparatus associated with the second destination information, associated with the first destination information, as the data transmission destination of the target data.

4. The control apparatus of claim 2,
wherein the first destination information is a universal resource locator (URL) indicating the data transfer destination of the target data, and the external terminal uploads the target data to an area identified by the URL to output the target data to the data transfer destination.

5. The control apparatus of claim 2,
wherein the first destination information is a mail address indicating the data transfer destination of the target data, and the external terminal outputs the target data to the data transfer destination using the mail address.

6. The control apparatus of claim 2,
wherein the circuitry is configured to generate connection information including the first destination information, and transmit the generated connection information to the information processing apparatus associated with the first destination information.

7. The control apparatus of claim 6,
wherein the connection information is a two-dimensional code including the first destination information, and
wherein the circuitry is configured to transmit the connection information to the information processing apparatus that performs at least one of printing and displaying of the two-dimensional code.

8. The control apparatus of claim 6,
wherein the connection information is communicated between the information processing apparatus and the external terminal using a short-range wireless communication, and
wherein the circuitry transmits the connection information to the information processing apparatus that performs the short-range wireless communication with the external terminal.

9. The control apparatus of claim 1,
wherein the condition includes information of an operation time range uniquely set for the information processing apparatus,
wherein when a current time corresponds to the operation time range uniquely set for the information processing apparatus, the circuitry designates the information processing apparatus as the data transmission destination of the target data.

10. The control apparatus of claim 1,
wherein the target data is print target data to be processed in the information processing apparatus having a printing function, and
wherein the circuitry is configured to adjust settings of the print target data to be printed using the information processing apparatus based on print setting information indicating preset print settings set for the information processing apparatus.

11. The control apparatus of claim 10,
wherein when a size of the print target data exceeds a size set for the print setting information, the circuitry is configured to reduce the size of the print target data.

12. The control apparatus of claim 1,
wherein, in response to transmitting an information acquisition request to the information processing apparatus from the control apparatus, the circuitry acquires the first destination information indicating the data transfer destination of the target data output from the external terminal, from the information processing apparatus.

13. The control apparatus of claim 12,
wherein the circuitry acquires print setting information indicating preset print settings of the information processing apparatus together with the first destination information, from the information processing apparatus.

14. An information processing control system comprising:
an information processing apparatus configured to process target data received from an external terminal; and
a control apparatus, controlling transmission of the target data from the external terminal to the information processing apparatus, the control apparatus including circuitry configured to
identify the information processing apparatus to be used as a data transmission destination of the target data, output from the external terminal, based on a condition uniquely set for the information processing apparatus;
receive the target data output from the external terminal; and
transmit the target data, received from the external terminal, to the identified information processing apparatus.

15. The information processing control system of claim 14,
wherein the information processing apparatus performs printing of the target data received from the external terminal via the control apparatus.

16. The information processing control system of claim 14,
wherein the information processing apparatus includes a display for displaying the target data received from the external terminal via the control apparatus.

17. A method of controlling data transmission from an external terminal to an information processing apparatus, the method comprising;
identifying the information processing apparatus as a data transmission destination of target data, output from the external terminal, based on a condition uniquely set for the information processing apparatus;
receiving the target data output from the external terminal; and
transmitting the target data, received from the external terminal, to the identified information processing apparatus.
